(19) United States
(12) Patent Application Publication
(10) Pub. No.: US 2007/0153930 A1
(43) Pub. Date: Jul. 5, 2007

(54) Apparatus, method and computer program product providing joint synchronization using semi-analytic root-likelihood polynomials for OFDM systems

(75) Inventor: Anthony Reid, Plano, TX (US)

Correspondence Address: HARRINGTON & SMITH, PC, 4 RESEARCH DRIVE, SHELTON, CT, 06484-6212, US

(73) Assignee: Nokia Corporation

(21) Appl. No.: 11/646,751

(22) Filed: Dec. 28, 2006

Related U.S. Application Data
(60) Provisional application No. 60/755,367, filed on Dec. 29, 2005.

(51) Int. Cl. H04K 1/10

(52) U.S. Cl. 375/260

(57) ABSTRACT

A method includes determining a number of observations. Each observation occurs at an observation time and corresponds to one of a number of received frequency multiplexed training symbols. The method also includes determining a number of roots of a first polynomial equation that is a function of a variable corresponding to frequency offset errors of carrier frequencies of the training symbols. Constants in the first polynomial equation are determined using at least the observations. The roots of the variable correspond to possible frequency offset errors. Based on at least the observations, the possible frequency offset errors, and possible symbol timing offset errors of the observation times of the training symbols, a number of estimated channel responses are determined corresponding to the training symbols. The method includes using a second polynomial equation that is a function of at least the estimated channel responses, the possible frequency offset errors, and the possible symbol timing offset errors, determining at least a resultant frequency offset error and a resultant symbol timing offset error. The method further includes using the resultant frequency offset error and resultant symbol timing offset error in order to receive at least one frequency multiplexed data symbol.

### CROSS-REFERENCE TO RELATED APPLICATION

This application claims priority to Provisional U.S. Patent Application No. 60/755,367, filed on Dec. 29, 2005, the contents of which is hereby incorporated by reference in its entirety.

### TECHNICAL FIELD

The exemplary and non-limiting embodiments of this invention relate generally to radio frequency receivers and, more specifically, relate to apparatus, methods and computer program products that determine receive channel estimation parameters, including timing offset and frequency offset estimations.

### BACKGROUND

The following abbreviations are herewith defined:
BER bit error rate
PER packet error rate
IFFT inverse fast Fourier transform
ML maximum likelihood
MLE maximum likelihood estimation
MAP maximum a posteriori
OFDM orthogonal frequency division multiplexing
CIR channel impulse response
CP cyclic prefix
MSE mean square error
PGA programmable gate array
WLAN wireless local area network

The determination of ML joint channel estimation parameters, along with symbol timing offset and frequency offset estimation for a wireless receiver that uses a preamble (or training sequences) in OFDM systems can be referred to as the synchronization problem for receivers. Most conventional receivers apply sequential estimation methods using separate OFDM training symbol sequences (e.g., preambles) for frequency offset, symbol timing offset and channel parameter estimation. The training sequences may have different structures to aid the sub-optimality of sequential estimation.

A joint estimation of these parameters can be used to perform the estimation task using one OFDM pre-amble symbol for typical OFDM systems, thus reducing packet inefficiency. Most systems using sub-optimal methods require more than one OFDM symbol for training (thus incurring reduced packet efficiency) and the overall estimates of parameters are sub-optimal leading to degradation in BER and/or PER relative to MLE.

MLE approaches are usually unattractive due to the inherent computational complexity of multi-dimensional parameter space searches, especially when channel state information is required for frequency selective wireless channels. For example, for IEEE 802.16e the cyclic prefix (i.e. channel delay spread) could be 32 samples. The “802.16e” refers to a standard that includes an amendment to the institute for electrical and electronics engineers (IEEE) Standard for Local and Metropolitan Area Networks Part 16: Air Interface for Fixed and Mobile Broadband Wireless Access Systems Amendment for Physical and Medium Access Control Layers for Combined Fixed and Mobile Operation in Licensed Bands. The standard 802.16e was approved on 7 Dec. 2005 and was published on 28 Feb. 2006. Therefore a brute force search would be over 34-dimensions (i.e., 32 channel parameters, frequency offset and symbol timing offset). Even with recent simplifications in channel state estimation (i.e., analytic solutions) the MLE approach is still left with the problem of a 2-dimensional search for frequency offset and symbol timing-offset estimation. The size of the search grid depends on both the frequency offset and symbol timing accuracy requirements. For example, a worst-case ±10 KHz frequency offset error with estimation accuracy requirement of 1 Hz would require 2×10⁴ step-sizes (i.e. grid points) for each symbol timing offset grid point to compute grid-points on the ML surface. The number of grid points for symbol timing recovery would be determined by the search region for expected symbol timing offset. A typical OFDM symbol may have 32-symbols for the cyclic prefix before data bearer symbols, so the number of symbol offsets for searching could be as much as 32 samples. Therefore the 2-dimension search grid for constructing a likelihood surface would require (32×2×10⁴) points. The maximum likelihood search would then determine the best (frequency-offset, symbol-timing offset) by choosing the point on the surface that minimizes the likelihood after the search is performed. Either smaller accuracy requirements or larger worst-case frequency offsets would require more grid points for the ML search.

The conventional channel estimation and synchronization approach performs each task sequentially based on the known preamble structure. For example, the WLAN legacy preamble structure suggests frequency offset estimation to be performed on repetitive short preambles, while symbol timing estimation and channel estimation are expected based on a long preamble. There are other joint estimation approaches. One approach is to obtain joint symbol timing and channel estimation without a frequency offset consideration (see Erik G. Larsson, Guoquing Liu, Jian Li, and Georgios B. Giannakis, “Joint Symbol Timing and Channel Estimation for OFDM Based WLANs,” IEEE Communication Letters, Vol. 5, No. 8, August 2001). Another approach is based on Maximum A Posterior (MAP) decision feedback estimation that relies on the channel decoder output (see JoonBeom Kim, Gordon Stuber, and Ye Li, “Iterative Joint Channel Estimation and Detection Combined with Pilot-Tone Symbols in Convolutionally Coded OFDM Systems,” The 14th IEEE 2003 PIMRC, Vol. 1, pp. 535-539, September 2003). A number of the classical references in this regard are as follows: S. Kay, “A Fast Accurate Single Frequency Estimator”, IEEE Transactions on Acoustics, Speech and Signal Processing, Vol. 37, No. 12, December 1989; R. E. Ziemer and R. L. Peterson, Digital Communications and Spread Spectrum Systems, MacMillan Publishing, 1985; W. J. Hurd, J. I. Sttuman and V. A. Vilnrotter, “High Dynamic GPS Receiver Using Maximum Likelihood Estimation and Frequency Tracking”, IEEE Transactions on Aerospace and Electronic Systems, Vol. AES-23, No. 4, July 1987; V. A. Vilnrotter, S. Hinedi and R. Kumar, “Frequency Estimation Techniques for High Dynamic Trajectories”, IEEE Transactions on Aerospace and Electronic Systems, Vol. 25, No. 4, July 1989; S. Aguirre and S. Hinedi, “Two Novel Automatic Frequency Tracking Loops”, IEEE Transactions on Aerospace and Electronic Systems, Vol. 25, No. 5, September 1989; M. Luise and R. Reggiannini, “Carrier Frequency Recovery in All-Digital Modems for Burst-Mode Transmissions”, IEEE Transactions on Communications, Vol. 43, No. 2/3/4, February/March/April 1995; Y. V. Zakharov, V. M. Baronkin and T. C. Tozer, “Maximum Likelihood Frequency Estimation in Multipath Rayleigh Sparse Fading Channels”, submitted to ICC2002; U. Mengali and A. N. D'Andrea, Synchronization Techniques for Digital Receivers, Plenum Press, New York, 1997; Juha Heiskala and John Terry, OFDM Wireless LANs: A Theoretical and Practical Guide, Sams Publishing, 2002; D. C. Rife and R. R. Boorstyn, Single-Tone Parameter Estimation from Discrete-time Observations, IEEE Transactions on Information Theory, Vol. IT-20, No. 5, September 1974; J. van de Beek, M. Sandell and P. Borjesson, ML Estimation of Time and frequency offset in OFDM systems, IEEE Transactions on Signal Processing, vol. 45, pp. 1800-1805, July 1999; D. Lee and K. Cheun, Coarse Symbol Synchronization algorithms for OFDM systems in Multipath Channels, IEEE Communications Letters, vol. 6, no. 10, pp. 446-448, October 2002; E. Larson, G. Liu, J. Li and G. Giannakis, Joint Symbol Timing and Channel Estimation for OFDM WLANS, IEEE Communications Letters, vol. 5, pp. 325-327, August 2001; T. M. Schmidl and D. C. Cox, Robust Frequency and Timing Synchronization for OFDM, IEEE Transactions on Communications, vol. 45, pp. 1613-1621, December 1997; I. Maniatis, T. Weber, A. Sklavos, Y. Liu, E. Costas, H. Haas and E. Schultz, Pilots for Joint Channel Estimation in Multi-user OFDM Mobile Radio Systems, IEEE 7 Int. Symposium on Spread Spectrum Tech. & Applications, Prague, Czech Republic, Sept. 2-5, 2002 and R. Negi and J. Cioffi, Pilot Tone Selection for Channel Estimation in a Mobile OFDM System, IEEE Transactions on Consumer Electronics, vol. 44, No. 3, August 1998.

Reference may also be had to commonly owned U.S. Pat. No. 6,975,839 B2, “Apparatus, and Associated Method, for Estimating Frequency Offset Using Filtered, Down-Sampled Likelihood Polynomials”, by Anthony Reid, wherein a number of required roots is reduced to but three or four for certain frequency offsets.

### BRIEF SUMMARY

In a first exemplary embodiment, a method is disclosed that includes determining a number of observations. Each observation occurs at an observation time and corresponds to one of a number of received frequency multiplexed training symbols. The method also includes determining a number of roots of a first polynomial equation that is a function of a variable corresponding to frequency offset errors of carrier frequencies of the training symbols. Constants in the first polynomial equation are determined using at least the observations. The roots of the variable correspond to possible frequency offset errors. Based on at least the observations, the possible frequency offset errors, and possible symbol timing offset errors of the observation times of the training symbols, a number of estimated channel responses are determined corresponding to the training symbols. The method includes using a second polynomial equation that is a function of at least the estimated channel responses, the possible frequency offset errors, and the possible symbol timing offset errors, determining at least a resultant frequency offset error and a resultant symbol timing offset error. The method further includes using the resultant frequency offset error and resultant symbol timing offset error in order to receive at least one frequency multiplexed data symbol.

In another exemplary embodiment, an apparatus is disclosed that includes synchronization circuitry coupleable to a receiver and configured to receive from the receiver information corresponding to a number of observations. Each observation occurs at an observation time and corresponds to one of a number of received frequency multiplexed training symbols. The synchronization circuitry is configured to determine a number of roots of a first polynomial equation that is a function of a variable corresponding to frequency offset errors of carrier frequencies of the training symbols, wherein constants in the first polynomial equation are determined using at least the observations, and wherein the roots of the variable correspond to possible frequency offset errors. The synchronization circuitry is also configured, based on at least the observations, the possible frequency offset errors, and possible symbol timing offset errors of the observation times of the training symbols, to determine a number of estimated channel responses corresponding to the training symbols. The synchronization circuitry is additionally configured, using a second polynomial equation that is a function of at least the estimated channel responses, the possible frequency offset errors, and the possible symbol timing offset errors, to determine at least a resultant frequency offset error and a resultant symbol timing offset error. The synchronization circuitry is further configured to cause the receiver to use the resultant frequency offset error and resultant symbol timing offset error in order to receive at least one frequency multiplexed data symbol.

In a further exemplary embodiment, a computer program product is disclosed that tangibly embodies a program of machine-readable instructions executable by a digital processing apparatus to perform operations comprising determining a number of observations, each observation occurring at an observation time and corresponding to one of a number of received frequency multiplexed training symbols. The operations include determining a number of roots of a first polynomial equation that is a function of a variable corresponding to frequency offset errors of carrier frequencies of the training symbols, wherein constants in the first polynomial equation are determined using at least the observations, and wherein the roots of the variable correspond to possible frequency offset errors. The operations include; based on at least the observations, the possible frequency offset errors, and possible symbol timing offset errors of the observation times of the training symbols, determining a number of estimated channel responses corresponding to the training symbols. The operations also include, using a second polynomial equation that is a function of at least the estimated channel responses, the possible frequency offset errors, and the possible symbol timing offset errors, determining at least a resultant frequency offset error and a resultant symbol timing offset error. The operations further include using the resultant frequency offset error and resultant symbol timing offset error in order to receive at least one frequency multiplexed data symbol.

In an additional exemplary embodiment, an apparatus is disclosed that includes synchronization means coupleable to a reception means and configured to receive from the reception means information corresponding to a number of observations, each observation occurring at an observation time and corresponding to one of a number of received frequency multiplexed training symbols. The synchronization means for determining a number of roots of a first polynomial equation that is a function of a variable corresponding to frequency offset errors of carrier frequencies of the training symbols, wherein constants in the first polynomial equation are determined using at least the observations, and wherein the roots of the variable correspond to possible frequency offset errors. The synchronization means is further, based on at least the observations, the possible frequency offset errors, and possible symbol timing offset errors of the observation times of the training symbols, for determining a number of estimated channel responses corresponding to the training symbols. The synchronization means is also for, using a second polynomial equation that is a function of at least the estimated channel responses, the possible frequency offset errors, and the possible symbol timing offset errors, determining at least a resultant frequency offset error and a resultant symbol timing offset error. The synchronization means is also for causing the means for receiving to use the resultant frequency offset error and resultant symbol timing offset error in order to receive at least one frequency multiplexed data symbol.

### BRIEF DESCRIPTION OF THE DRAWINGS

In the attached Drawing Figures:

FIG. 1 shows an OFDM packet training sequence structure in accordance with IEEE 802.16e.

FIG. 2 shows a MLE likelihood surface (e.g., for a Monte Carlo iteration) and timing/frequency offset minimum.

FIG. 3 shows MLE performance for frequency/symbol timing offset for 50 Monte Carlo iterations, where FIG. 3A shows frequency offset, FIG. 3B shows symbol timing offset, and FIG. 3C shows channel responses and associated errors.

FIG. 4 shows Likelihood Coefficients, roots and frequency offsets for one Monte Carlo iteration, where FIG. 4A shows likelihood polynomial coefficients on the z-plane, FIG. 4B shows likelihood polynomial roots on the z-plane, and FIG. 4C shows frequency offsets versus root index.

FIG. 5 shows processing flow for MLE synchronization using decimated polynomials.

FIG. 6 shows likelihood polynomials, both un-decimated/decimated, with the decimation filter shown, where FIGS. 6A and 6B show magnitude and phase, respectively, for a low-pass filter which can be specialized to the zero-phase filter of FIG. 5, FIG. 6C shows coefficients of an unfiltered polynomial, and FIG. 6D shows coefficients of a filtered polynomial.

FIG. 7 shows frequency/phase response likelihood polynomials, un-decimated and decimated, where FIGS. 7A and 7B show magnitude and phase, respectively, of an un-decimated likelihood polynomial, and FIGS. 7C and 7D show magnitude and phase, respectively, of a decimated likelihood polynomial.

FIG. 8 illustrates a likelihood surface, decimated grid for searching likelihood (for a single Monte Carlo iteration).

FIG. 9 illustrates MLE Performance for decimated polynomials for 50 Monte Carlo iterations, where FIG. 9A shows frequency offset, FIG. 9B shows symbol timing offset, and FIG. 9C shows channel responses and associated errors.

FIG. 10 illustrates frequency offset/symbol timing offset for a training sequence=64 FFT bins for IEEE 802.16e assuming an exponential channel, where FIG. 10A shows frequency offset, FIG. 10B shows symbol timing offset, FIG. 10C shows channel impulse response (CIR), and FIG. 10D shows total channel error per packet.

FIG. 11 illustrates frequency offset/symbol timing offset for a training sequence=64, 128 symbols for IEEE 802.16e assuming an exponential channel, where FIG. 11A shows frequency offset and FIG. 11B shows symbol timing offset.

FIG. 12 illustrates graphs of bi-variate likelihood polynomial root-finding, where FIG. 12A shows magnitude of roots and FIG. 12B shows corresponding frequency offset of the roots shown in FIG. 12B, and where FIG. 12C shows magnitude of roots and FIG. 12D shows corresponding symbol timing offset of the roots shown in FIG. 12B.

FIG. 13 is a table depicting IEEE 802.16e OFDM parameters.

FIG. 14 shows a simplified block diagram of various electronic devices that are suitable for use in practicing the exemplary embodiments of this invention.

FIG. 15 is a flow chart of an exemplary method for joint synchronization using semi-analytic root-likelihood polynomials.

FIG. 16 is a flow chart corresponding to a portion of the method of FIG. 15.

FIG. 17 is a block diagram of an apparatus suitable for implementing exemplary embodiments of the disclosed invention.

### DETAILED DESCRIPTION

By way of introduction, the exemplary embodiments of this invention provide a semi-analytic search algorithm to determine the Maximum Likelihood (ML) joint channel estimation parameters, along with symbol timing offset and frequency offset estimation for a wireless receiver that uses a preamble (or training sequences) in OFDM systems, thereby addressing the receiver synchronization problem.

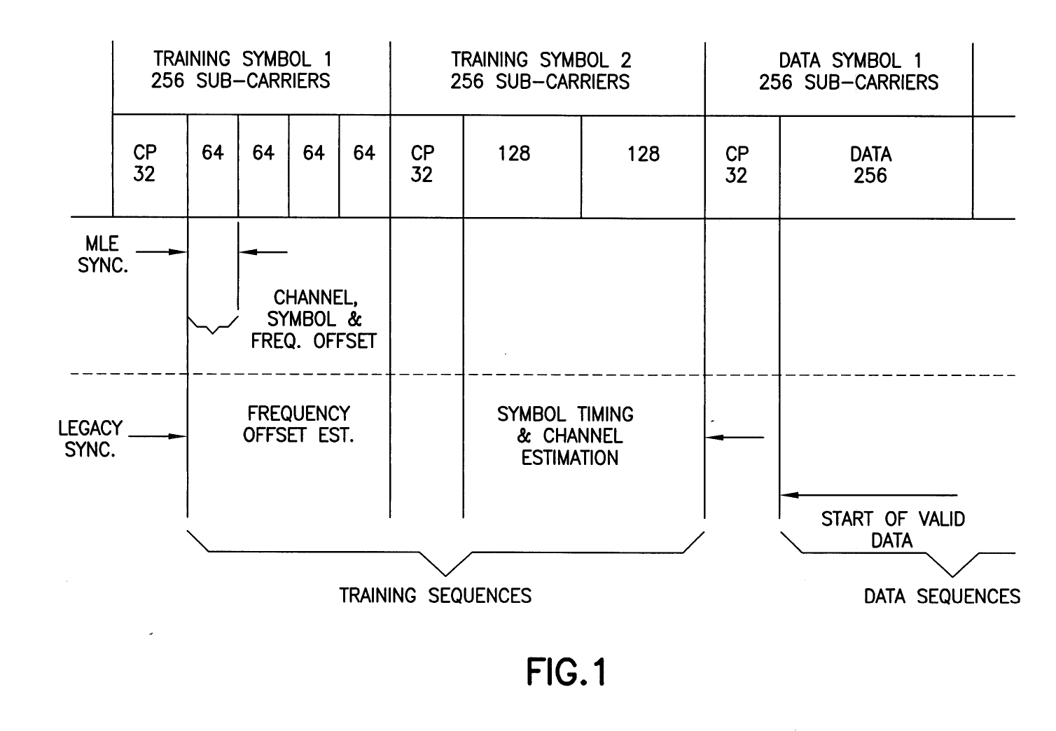

The use of the exemplary embodiments of this invention significantly reduces the search grid for frequency offsets by root-finding over down-sampled likelihood polynomials for candidate frequency-offsets. The down-sampling step results in a significant computational savings associated with root-finding over the data samples associated with the sampled system bandwidth. For example, the synchronization pre-amble for IEEE 802.16e OFDM mode has N=256 training symbols in the first pre-amble OFDM symbol for synchronization (see FIG. 1). The number of roots computed for frequency offset would be N=512 roots, and is independent of the maximum expected frequency offset. This technique is sometimes called a super-resolution approach because the number of computed grid-points is not related resolution/maximum frequency-offset specifications. A grid-based search technique for ±10 KHz with 1 Hz resolution would require 2×10⁴ step-sizes as noted previously. This method is semi-analytic because the grid points for searching the likelihood surface are constructed by generating a set of frequency offsets for each hypothesized symbol-timing offset. Therefore the 2-dimensional set of grid-points needed to be searched would be (512×32=16384 ) grid-points, compared to 6.4×10⁵ grid points for a full 2-dimensional search. This is a 98% savings in grid points. Furthermore more savings are realized when the likelihood polynomial in frequency offset is decimated to a smaller number of points before roots are computed. This step is possible because the maximum frequency offset is usually a small fraction of the sampled bandwidth. For a typical 5 MHz bandwidth for an IEEE 802.16e system, a 10 KHz maximum frequency offset equates to 0.2% of sampled bandwidth. A decimation factor of at least 10 may be used to down-sample the likelihood polynomial resulting in at least another 10% reduction in grid points in frequency offset for the likelihood search.

A further extension of this approach exploits the polynomial structure of the symbol-timing offset in the frequency domain to allow root-finding of a bi-variate polynomial to directly determine both frequency and symbol-timing offset grid-points for constructing the likelihood surface. This is a direct approach ML approach because the roots of a bi-variate likelihood polynomial determine the grid-points for the likelihood surface construction. This solution may not necessarily reduce the search complexity, but it can yield a performance improvement in ML estimates by determining symbol-timing offsets that are at non-integer time epochs. This property of super-resolution is a consequence of root-finding in both frequency-offset and symbol-timing offset.

The explicit details of the packet/pre-amble structure related to the exemplary embodiments of this invention are shown in FIG. 1, which illustrates the typical structure for an OFDM packet for IEEE 802.16e. Two training symbols are specified for synchronization. Each training symbol is composed of a CP and 256 time samples related to 256 frequency bins for IFFT. The first training symbol is intended for frequency offset estimation. Repetitive groups of 64 time samples are created with repetitive frequency domain signals. The second training symbol is intended for both symbol timing offset and channel estimation. There are two long training sequences of 128 time samples for that purpose. Any sequential synchronization algorithm should work reasonably well with two training OFDM symbols. A MLE joint synchronization algorithm does not require separate training symbols with special structure beyond randomness. As shown in FIG. 1, the first 64 time samples after cyclic prefix in the first training symbol can be used for synchronization. Increasing the number length of the training sequence can improve synchronization performance. Results for 2-64 repetitive segments demonstrate the versatility of the use of the exemplary embodiments of this invention. Furthermore, it may be preferred to use a random sequence of 128 samples rather than two repetitive segments of 64 samples each.

For OFDM systems with a typical packet structure defined in R. van Nee, G. Awater, M. Morikura, H. Takansashi, M. Webster and K. Halford, New High-Rate Wireless LAN Standards, IEEE Communications Magazine, vol. 37, pp. 82 88, December 1999, let Xₙ denote the symbol taken from an alphabet β where Xₙ is i.i.d. The resulting M-point time domain signal for an OFDM symbol is generated by taking an M point IDFT

$$s ( ρ ) = \frac{1}{\sqrt{M}} {\sum }_{n = 0}^{M - 1} {X}_{n} {ⅇ}^{\frac{j2πω}{M}} \qquad ( 1 )$$

of variance as σₛ². The time domain signal s(ρ) is convolved with the channel impulse response h(ρ) . A maximum likelihood estimator (MLE) can be derived for jointly estimating symbol timing offset error θ, frequency offset error c and channel impulse response at the receiver. Each received observation z_{ρ} at time ρ is represented as
z_{ρ}=B_{ρ}e^{j(ωρT)}+n_{ρ}=B_{ρ}k_{ρ}+n_{ρ} (2)
where T is the sampling interval between observations, B_{ρ} is the amplitude of the signal which is formed as

$$\begin{matrix}{B}_{ρ} = {\sum }_{l = 0}^{{N}_{m} - 1} {h}_{l} s ( ρ - l - θ ) \\ or & ( 3 ) \\ {z}_{ρ} = \{ {\sum }_{l = 0}^{{N}_{m} - 1} {h}_{l} s ( ρ - l - θ ) \} {ⅇ}^{jωρ T} + {n}_{ρ} & ( 4 )\end{matrix}$$

where hₗ is the impulse response of an FIR channel of length Nₘ. The received channel symbols experience a symbol timing offset s(ρ-l-θ) with respect to transmitted symbols, with symbol timing offset error denoted by θ. The symbol timing offset error is an error with respect to expected time of reception of the symbols. It is noted that “symbol timing offset error” may be shortened herein to “symbol timing offset” or “timing offset”. Likewise each received sample experiences a frequency offset error (e.g., relative to an expected carrier frequency of a symbol) due to frequency differences in oscillators between the received and transmitted symbols. The term “frequency offset error” may also be shortened herein to “frequency offset”. The substitution k_{ρ}=e^{jωρT}=(e^{jωT})^{ρ} is used to simplify notation. The receiver noise is modelled as an additive noise term n_{ρ} which is a zero mean, complex i.i.d. (independent and identically distributed) Gaussian random variable with variance σ_{ρ}². A likelihood function (see H. L. Van Trees, Detection, Estimation and Modulation Theory: Part 1, John Wiley and Sons, New York, N.Y., Chapter 2, 1968) is formed from a vector of N=Nₗ+Nₘ observations of a complex Gaussian vector process Z_{N}=[z_{ρ},z_{ρ+1}, z_{ρ+2}, . . . ,z_{N-1}]^{T} with vector K_{N}=[k_{ρ},k_{ρ+1},k_{ρ+2}, . . . ,k_{N-1}]^{T} and diagonal matrix B_{N}=diag(└B_{ρ},B_{ρ+1},Bₚ₊₂, . . . ,B_{N-1}┘). Parameters θ, ω and hₗ,l=0, . . . , Nₘ−1 are the desired unknowns and the symbols └B_{ρ},B_{ρ+1},B_{ρ+2}, . . . ,B_{N-1}┘ are known when training symbols Xₙ are transmitted across the channel. Letting h=└h₀,hₗ, . . . ,h_{N}_{ₘ}₋₁┘, the likelihood function is defined as

$$Λ ( {Z}_{N} \vert θ , ω , h ) = \frac{1}{{[ 2 π ]}^{\frac{N}{2}} {\vert W \vert}^{\frac{1}{2}}} exp \{ - \frac{1}{2} {( {Z}_{N} - {B}_{N} {K}_{N} )}^{*} {W}^{- 1} ( {Z}_{N} - {B}_{N} {K}_{N} ) \} \qquad ( 5 )$$

where symbol “*” denotes Hermitian transpose and matrix W(ρ,τ)=E{n*_{ρ}n_{τ}}. Assuming Nₗ transmitted symbols pΔ[s(0),s(1), . . . s(N₁−1)]^{T}, and zΔ[z(θ),z(θ+1), . . . z(θ+Nₗ+Nₘ−1)]^{T} received observations. Using similar notation as in W. C. Lim, B. Kannan and T. T. Tjhung, Joint Channel Estimation and OFDM Synchronization in Multipath Fading, ICC 2004, Paris, France, equation (5) becomes

$$\begin{matrix}Λ ( {Z}_{N} \vert θ , ω , h ) = \frac{1}{{[ 2 π ]}^{\frac{π}{2}} {\vert W \vert}^{\frac{1}{2}}} exp \{ - \frac{1}{2} {\sum }_{ρ = θ}^{θ + N - 1} \frac{( {z}_{ρ} - {μ}_{ρ} ) {( {z}_{ρ} - {μ}_{ρ} )}^{*}}{{σ}_{ρ}^{2}} \} \\ where & ( 6 ) \\ {μ}_{ρ} = {B}_{ρ} {k}_{ρ} & ( 7 )\end{matrix}$$

Now taking, the negative of the (natural) logarithm of the likelihood function and letting σ_{ρ}² =σ² yields a new likelihood function. (The limits are taken over constant terms in preparation for derivatives ∂Λ′/∂θ for bi-variate polynomials in the development of the direct form of likelihood equations.)

$$Λ = - ln Λ ( {Z}_{N} \vert θ , ω , h ) = - \frac{1}{2 {σ}^{2}} \{ {\sum }_{ρ = 0}^{{θ}_{MAX} + N - 1} {μ}_{ρ} {z}_{ρ}^{*} + {\sum }_{ρ = 0}^{{θ}_{MAX} + N - 1} {μ}_{ρ}^{*} {z}_{ρ} - {σ}_{s}^{2} {N}_{l} {\sum }_{l = 0}^{{N}_{m} - 1} {‖ {h}_{l} ‖}^{2} \} \qquad ( 8 )$$

and the constant term

$$ln ( {[ 2 π ]}^{\frac{N}{2}} {\vert W \vert}^{\frac{1}{2}} )$$

is ignored w.r.t. ensuing derivative operations. The term θ_{MAX} corresponds to a maximum search parameter for symbol offset timing. The MLE solution is formed starting with the partial derivatives

$$\frac{\partial {Λ}^{′}}{\partial {h}_{i}} = 0 , ∀ i and \frac{\partial {Λ}^{′}}{\partial ω} = 0 , \frac{\partial {Λ}^{′}}{\partial θ} = 0 \qquad ( 9 )$$

The partial differentiation ∂Λ′/∂ω yields a functional form

$$\begin{matrix}\frac{\partial }{\partial ω} \{ - ln Λ ( {Z}_{N} \vert θ , ω , h ) \} = - {\sum }_{ρ = θ}^{θ + N - 1} {B}_{ρ} ( θ , ω ) \frac{\partial {k}_{ρ}}{\partial ω} {z}_{ρ}^{*} - {\sum }_{ρ = θ}^{θ + N - 1} \frac{\partial {B}_{ρ} ( θ , ω )}{\partial ω} {k}_{ρ} {z}_{ρ}^{*} - {\sum }_{ρ = θ}^{θ + N - 1} {B}_{ρ}^{*} ( θ , ω ) \frac{\partial {k}_{ρ}^{*}}{\partial ω} {z}_{ρ} - {\sum }_{ρ = θ}^{θ + N - 1} \frac{\partial {B}_{ρ}^{*} ( θ , ω )}{\partial ω} {k}_{ρ}^{*} {z}_{ρ} . \\ where & ( 10 ) \\ {B}_{ρ} ( θ , ω ) = {\sum }_{l = 0}^{{N}_{m} - 1} {h}_{l} s ( ρ - l - θ ) = \frac{1}{{N}_{l} {σ}_{s}^{2}} {\sum }_{l = 0}^{{N}_{m} - 1} {\sum }_{v = θ + 1}^{θ + l + {N}_{l} - 1} {z}_{v} {s}^{*} ( v - θ - l ) s ( ρ - l - θ ) {k}_{v}^{*} \\ and & ( 11 ) \\ \frac{\partial }{\partial ω} {B}_{ρ} ( θ , ω ) = - \frac{j T}{{N}_{l} {σ}_{s}^{2}} {\sum }_{l = {l}_{1}}^{{l}_{2}} {\sum }_{v = θ - 1}^{θ + l + {N}_{l} - 1} {vz}_{v} {s}^{*} ( v - θ - l ) s ( ρ - l - θ ) {k}_{v}^{*} & ( 12 )\end{matrix}$$

where the substitution for hᵢ is determined below. The partial differentiation ∂Λ′/∂hᵢ=0 yields a functional form

$$\begin{matrix}- \frac{\partial \{ ln Λ ( {Z}_{N} \vert θ , ω , {h}_{i} \} )}{\partial {h}_{i}} = \frac{\partial }{\partial {h}_{i}} \{ \begin{matrix}{\sum }_{ρ = 0}^{{θ}_{MAX} + N - 1} {μ}_{ρ} {z}_{ρ}^{*} + \\ {\sum }_{ρ = 0}^{{θ}_{MAX} + N - 1} {μ}_{ρ}^{*} {z}_{ρ} - \\ {σ}_{s}^{2} {N}_{l} {\sum }_{l = 0}^{{N}_{m} - 1} {‖ {h}_{l} ‖}^{2}\end{matrix} ) = 0 \\ = \{ \begin{matrix}{\sum }_{ρ = 0}^{{θ}_{MAX} + N - 1} {z}_{ρ}^{*} {k}_{ρ} {\sum }_{l = 0}^{{N}_{m} - 1} \frac{\partial }{\partial {h}_{i}} \{ {h}_{l} \} s ( ρ - l - θ ) + \\ {\sum }_{ρ = 0}^{{θ}_{MAX} + N - 1} {z}_{ρ} {\sum }_{l = 0}^{{N}_{m} - 1} \frac{\partial }{\partial {h}_{i}} \{ {h}_{l}^{*} \} {s}^{*} ( ρ - l - θ ) {k}_{ρ}^{*} - \\ {σ}_{s}^{2} {N}_{l} {\sum }_{l = 0}^{{N}_{m} - 1} \frac{\partial }{\partial {h}_{i}} {‖ {h}_{l} ‖}^{2}\end{matrix} \} \\ = {\sum }_{ρ = 0}^{{θ}_{MAX} + N - 1} {z}_{ρ}^{*} s ( ρ - i - θ ) {k}_{p} - {σ}_{s}^{2} {N}_{l} {h}_{i}^{*} = 0\end{matrix} \qquad ( 13 )$$

noting that a,

$$\frac{\partial }{\partial {h}_{i}} {‖ {h}_{i} ‖}^{2} = \frac{\partial }{\partial {h}_{i}} \{ {h}_{i} {h}_{i}^{*} \} ,$$

and the properties of complex derivatives

$$\frac{\partial }{\partial {h}_{i}} \{ {h}_{i}^{*} \} = 0 and \frac{\partial }{\partial {h}_{i}} \{ {h}_{i} \} = 1$$

(see S. Haykin, Adaptive Filter Theory: Third Edition, Prentice-Hall, Inc.; New Jersey, 1996, pp. 890, 891). This simpler derivation yields the same result as shown in W. C. Lim et al., Joint Channel Estimation and OFDM Synchronization in Multipath Fading, thus the minimization w.r.t. h yields

$${\hat{h}}_{i} = \frac{1}{{N}_{l} {σ}_{s}^{2}} {\sum }_{ρ = θ + i}^{θ + i + {N}_{l} - 1} {z}_{ρ} {s}^{*} ( ρ - θ - i ) {k}_{ρ}^{*} , i = 0 , 1 , … , {N}_{m} - 1 \qquad ( 14 )$$

It should be noted that this solution exploits the processing gain associated with a random but known training sequence for each channel tap since the computation is a correlation. Now instead of searching over a quantized set of points for both θ,ω, the minimization w.r.t. ω is performed following the substitution of equation (14) into B_{ρ} in likelihood equation (8) which now makes B_{ρ} a function of θ,ω. Letting it u=e^{jωT} then equation (10) becomes a polynomial in it u^{ρ-ν}, u^{-(ρ-ν)}

$$\frac{\partial \{ - ln Λ ( {Z}_{N} \vert θ , ω , h ) \}}{\partial ω} = {\sum }_{l = {l}_{1}}^{{l}_{2}} {\sum }_{ρ = 0}^{θ + N - 1} {\sum }_{v = θ + l}^{θ + l + {N}_{l} - 1} [ \begin{matrix}\{ ρ - v \} {D}_{1} ( θ , l , ρ , v ) {u}^{ρ - v} + \\ \{ v - ρ \} {D}_{1}^{*} ( θ , l , ρ , v ) {u}^{- ( ρ - v )}\end{matrix} ] = 0 , \qquad ( 15 )$$

where Dₗ(θ,l,ρν)=z*_{ρ}z_{ν}s*(ν−θ−l)s(ρ−l−θ). roots of this polynomial determine partial criteria for the minimum of the likelihood function. Factoring out the term u^{-(P-1)} yields a polynomial in positive exponents for u where P=Nₗ+Nₘ−1 is the maximum positive value for (ρ31 ν) over indices ρ,ν.

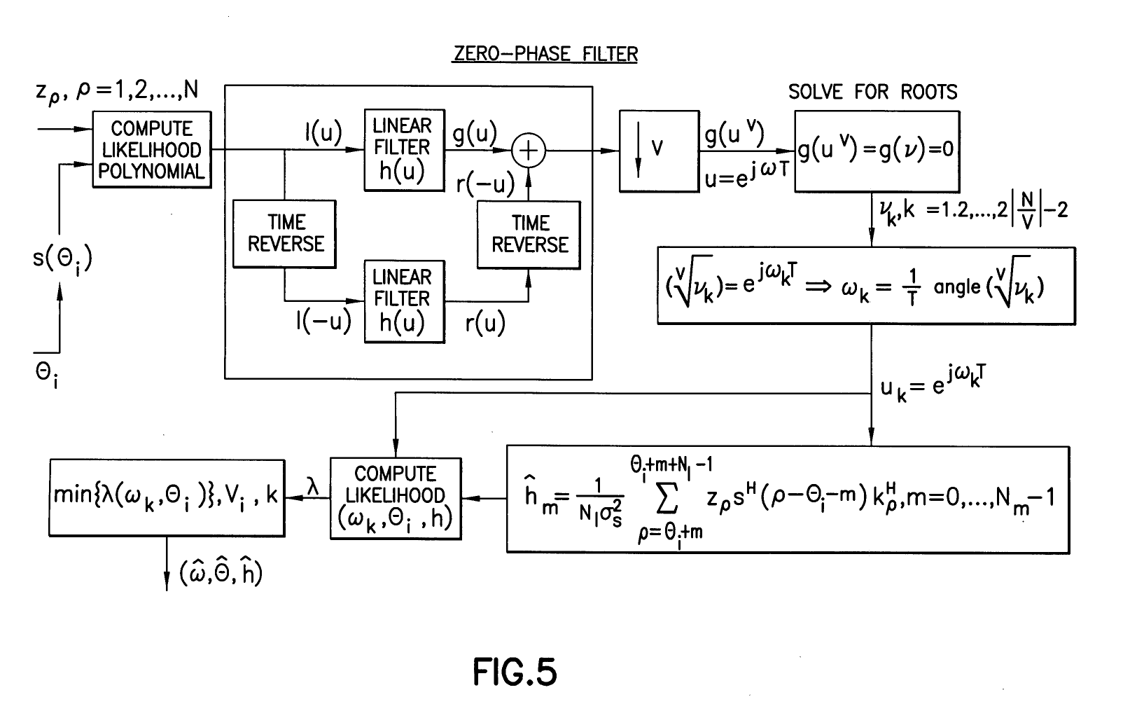

The MLE for θ,ω and h is formed as follows (refer to method 500 of FIG. 5):
1) For each θₗ (i.e., hypothesized symbol timing offset) (block 505);
2) Solve for the roots of u in equation (15) (block 510);
3) Determine ω_{r,l} in u=e^{jωT} (block 515);
4) Compute

$${\hat{h}}_{i , r , l} = \frac{1}{{N}_{l} {σ}_{s}^{2}} {\sum }_{ρ = {θ}_{l} - i}^{{θ}_{l} + i + {N}_{l} + 1} {z}_{ρ} {s}^{*} ( ρ - {θ}_{l} - i ) {k}_{ρ , r}^{*} , i = 0 , 1 , … , {N}_{m} - 1$$

using k_{ρ,r}=e^{jω}_{^{r}}^{ρT} (block 520);
5) Compute μ_{ρ,i,r,l} in equation (7) using (θₗ,ωᵣ,ĥ_{i,r,l}) (block 525);
6) Evaluate the log-likelihood function in equation for all tuples of roots (θₗ,ωᵣ,ĥ_{i,r,l}) using equation (8) (block 530);
7) If ALL hypothesized symbol offsets searched CONTINUE to step 8 otherwise go to Step 1
8) The symbol timing offset error, frequency-offset error and channel estimate is determined as the tuple (θₗ,ωᵣ,h_{i,r,l}) which minimizes the log-likelihood function

$$( \hat{u} , \hat{θ} , \underline{\hat{h}} ) = {min}_{( {θ}_{l} , {ω}_{r} , {h}_{r , l} )} \{ - ln Λ ( {Z}_{N} \vert θ , ω , \underline{h} ) \} .$$

It is noted that the resultant tuple (θ,ω,h) and in particular the symbol timing offset error and frequency-offset error may be used to adjust a transceiver/receiver to receive data symbols (block 540).

The polynomial in equation (15) is expanded as

$${c}_{2 P - 1} {u}^{2 P - 2} + {c}_{2 P - 2} {u}^{2 P - 3} + … + {c}_{P + 1} {u}^{P} + 0 \cdot {u}^{P - 1} + {c}_{P - 1} {u}^{P - 2} + … + {c}_{1} = 0 \qquad ( 16 )$$

where each cᵢ is evaluated by performing the appropriate summations indicated in equation (15). The number of roots could also be reduced further by performing a second derivative test on the roots to determine if extrema points are maximum or minimum (see W. Kaplan, Advanced Calculus, Addison-Wesley Publishing Company, Inc., July 1959) and discarding the appropriate frequency offset roots from the search grid.

The complexity of this approach is dominated by the root-finding procedure. For a typical OFDM system (e.g., WLAN), the roots of at least a 130^{th}-order polynomial would have to be computed. Therefore this approach is computationally less attractive than sub-optimal methods of approximate MLE (see U. Mengali and A. N. D'Andrea, Synchronization Techniques for Digital Receivers, Plenum Press, New York, 1997) or simple linear regression techniques (see S. Kay, “A Fast Accurate Single Frequency Estimator”, IEEE Transactions on Acoustics, Speech and Signal Processing, Vol. 37, No. 12, Dec. 1989 and S. A. Tretter, “Estimating the Frequency of a Noisy Sinusoid by Linear Regression”, IEEE Transactions on Information theory, Vol. IT-31, No. 6, November 1985). But many of these approaches rely on the “small angle approximation” in the phase term of an exponential to simplify computational complexity when finding frequency offset estimates. This places a restriction on the maximum frequency offset, whereas MLE approaches are restricted only by the sampled bandwidth of the system.

The following discussion illustrates certain characteristics of results using the likelihood polynomial for frequency offset estimation and symbol timing recovery. A contrived OFDM symbol is constructed for demonstration purposes. Table 1 summarizes the parameters for this case.

TABLE 1
Parameter Settings

| Parameter | Value | |
|---|---|---|
| Sampling Frequency (fₛ) | 128 | Hz. |
| Number of Training Symbols (Nₗ) | 64 | |
| IFFT for OFDM symbol (M) | 128 | |
| Input Signal Amplitude \|B\| | 1 | |
| Input signal SNR | 10 | (dB.) |
| Modulation for subcarriers | BPSK | |
| Frequency Offset Error (fᵣ) | 2 | Hz |
| Timing Offset Error (θ) | 0, 1, . . . , 9 Time epochs | |
| Number of channel coefficients, Nₘ | 2 | |
| Number of Monte Carlo Runs | 50 | |

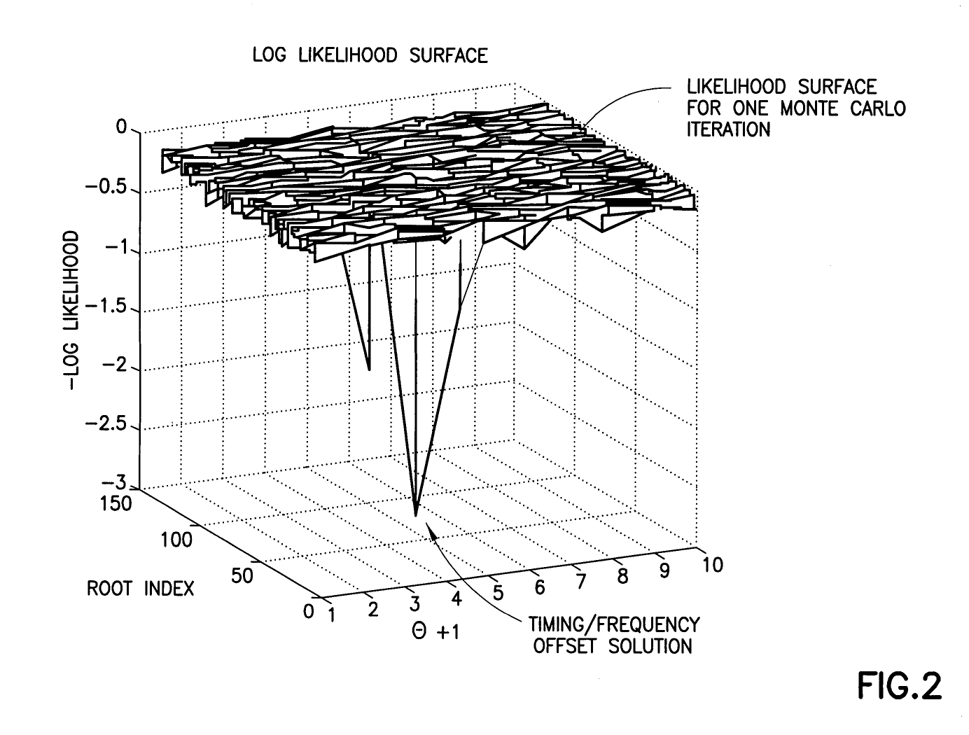

FIG. 2 shows the log-likelihood surface for the search over phase and frequency offset for a typical Monte Carlo run. The roots computed from the likelihood polynomial are stored in a vector in no particular order. For each hypothesized symbol offsets θₖ, k=0, 1, . . . , 9, the roots are computed from the likelihood polynomial. There are 130 roots computed for each θₖ. The minimum of the log-likelihood surface corresponds to the MLE for symbol timing estimate and the corresponding root associated with the minimum is the frequency offset estimate. For this Monte Carlo run \hat{θ}=4,\hat{f}=2.02ᵣ Hz.

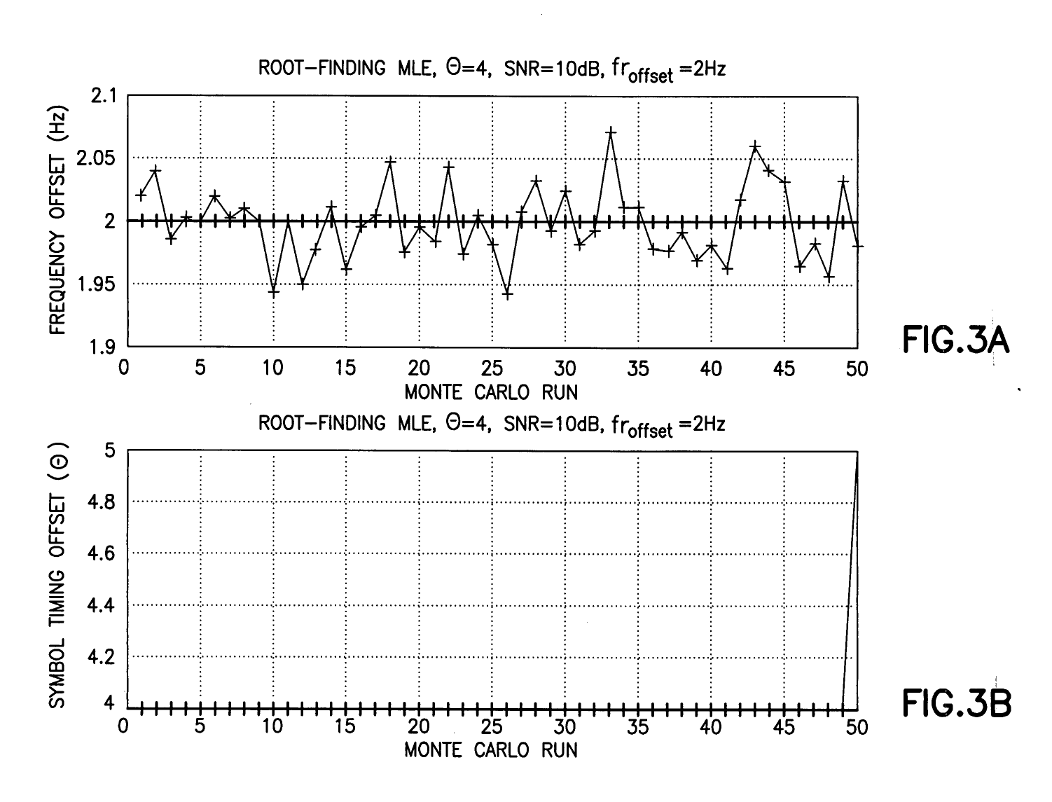

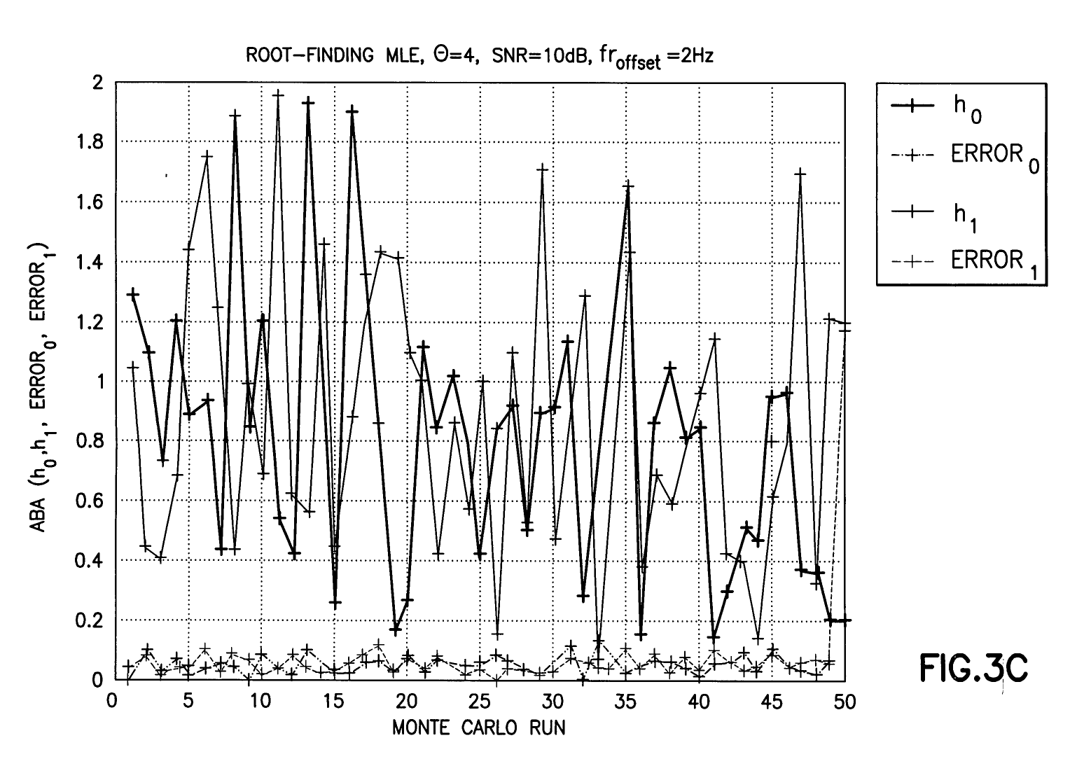

FIG. 3 shows frequency and symbol timing offsets for 50 Monte Carlo runs. Frequency offset estimates are in good agreement with the actual frequency offset of 2 Hz. The symbol timing offset estimates coincide with the actual phase offset of θ=4 time epochs except for the last Monte Carlo run (i.e. 50) where the \hat{θ}=5 time epochs. Despite this error the frequency estimate is still very accurate for Monte Carlo run at 50. FIG. 3 also shows the corresponding channel impulse response (CIR) for the 2-tap channel. Each coefficient is a random sample from a complex Gaussian pdf with σₕ_{ᵢ}²=1. The absolute error or ∥hᵢ−ĥᵢ∥,i=0,1 is also plotted for each estimated channel coefficient. As shown the estimation error is quite small relative to the magnitude of the channel coefficients.

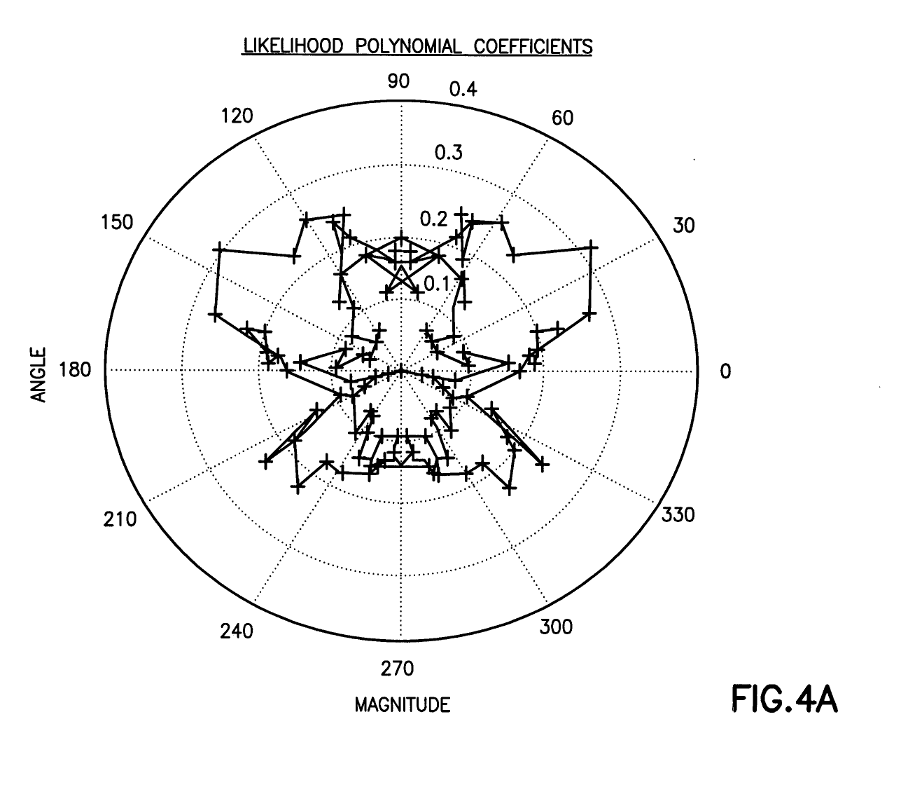

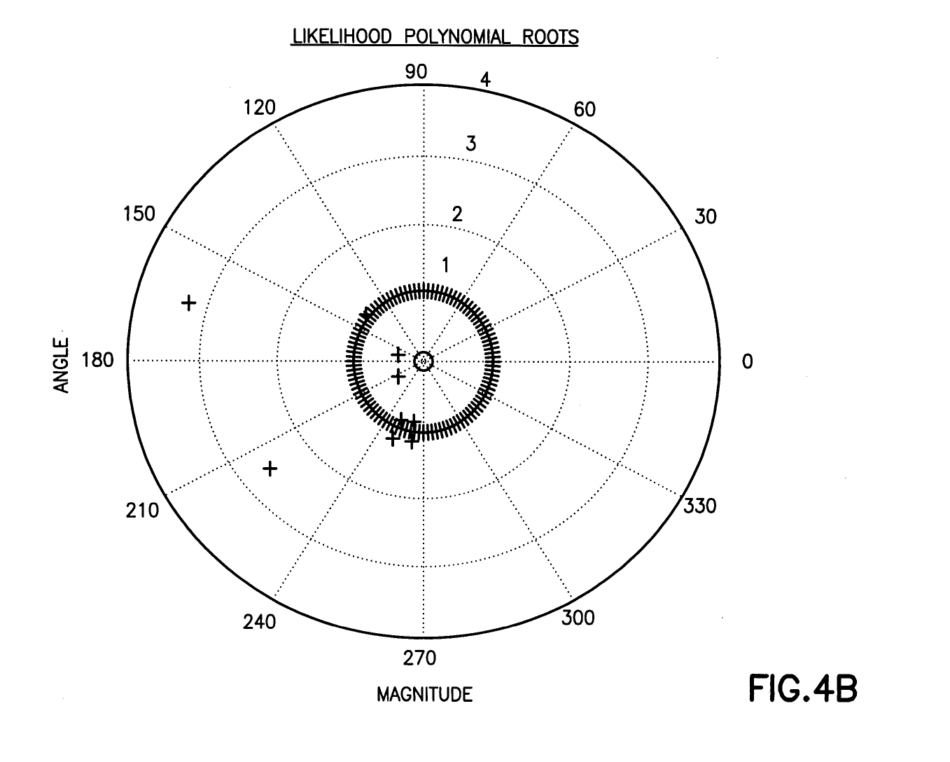

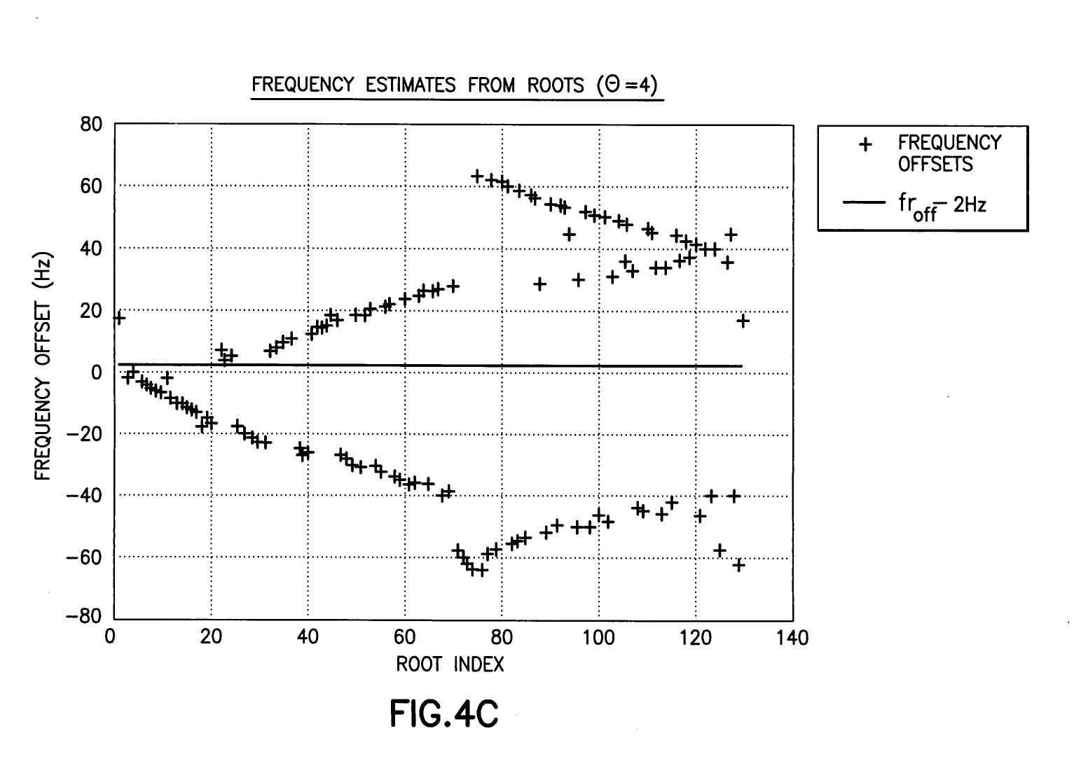

FIG. 4 shows the complex z-plane representation of the coefficients of the likelihood polynomial. There are 2(Nₗ+Nₘ−1)=130 coefficients in the likelihood polynomial (see equation (16). Note can be taken of the visual symmetry of the coefficients about the complex j-axis due to the construction in equation (15). This property could be useful for further reducing the complexity of root-finding. FIG. 4 also shows z-plane plot of roots uᵢ of the likelihood polynomial. Most of the roots are located on the unit circle. There are a few roots that are located inside and outside the unit circle. Notice that these roots are much larger than the frequency offset of 2 Hz (˜5 degrees) and should have insignificant values on the likelihood surface.

FIG. 4 also shows the frequency offset estimates from the roots of the likelihood polynomial using uᵢ=e^{jω}_{ₒ}^{T} and solving for ωᵢ. Notice the near-intersection of the true offset 2 Hz with one of the roots at root index 21. This root also corresponds to symbol timing offset roots for θ=4. Also note that the frequency offset estimates are not necessary in complex conjugate pairs because the coefficients of the roots are not necessarily complex conjugate pairs.

Discussed now is the use of a decimated likelihood polynomial. This discussion shows some characteristics of results using the decimated likelihood polynomial for frequency offset estimation and symbol timing recovery. Reference may also be had to the above-noted U.S. Pat. No. 6,975,839 B2. The general idea is to filter and decimate the likelihood polynomial, since the frequency offset is a small fraction of the overall sampled bandwidth.

FIG. 5 shows the decimation step in the processing flow. Note that FIG. 5 may be viewed as a circuit block diagram or as a logic flow diagram, or as a combination of each. A summary of the decimation steps is described below. The first step is to compute the likelihood polynomial l(u) as shown in equation (15) using all observables for each hypothesized symbol timing offset θₗ. The next step is to apply a low-pass, zero-phase filter to l(u) so there is no phase-offset on the unit circle due to the frequency response of any causal filter h(u) (see A. V. Oppenheim and R. W. Shafer, Digital Signal Processing, Prentice-Hall, Inc. New Jersey, 1975). This is accomplished by the composite operations of low-pass filtering l(u) to yield g(u) . Time reversed signal l(−u) is also filtered through h(u) to yield r(u) which is time-reversed. The new low-pass filtered polynomial l′(u)=g(u)+r(−u) is decimated by factor V. The filter length is selected with care to minimize computational complexity while achieving the goals of a flat passband and low ripple stop bands to avoid aliasing. With it u=e^{jωT} the resulting polynomial is q(u^{ν})=q(ν) with order 2└P/V┘−2. The polynomial q(ν) is a function containing the information to extract the frequency offset. The frequency offset information should be preserved due to low pass filtering and zero-phase delay from low-pass filtering. The primary roots are found by solving for

$${v}_{i} , i = 1 , 2 , … , 2 ⌊ \frac{P}{V} ⌋ - 2 and {ω}_{i}$$

is determined from

$$exp ( {jω}_{i} T ) = \sqrt[V]{{v}_{i}} ⇒ {ω}_{i} = \frac{1}{T} arg ( \sqrt[V]{{v}_{i}} ) \qquad ( 17 )$$

If it is desired to find all the roots then

$${ω}_{i , p} = \frac{1}{T} \{ arg ( \sqrt[V]{{v}_{i}} ) + \frac{2 π}{V} p \} , p = 0 , 1 , … , V - 1 \qquad ( 18 )$$

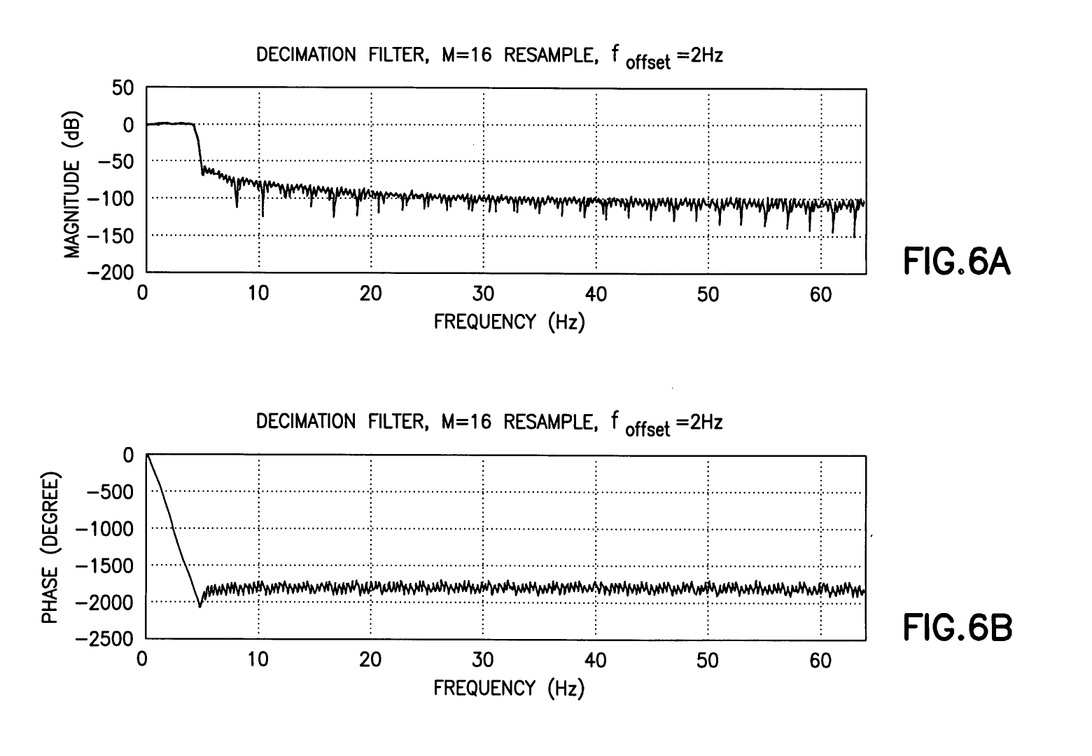

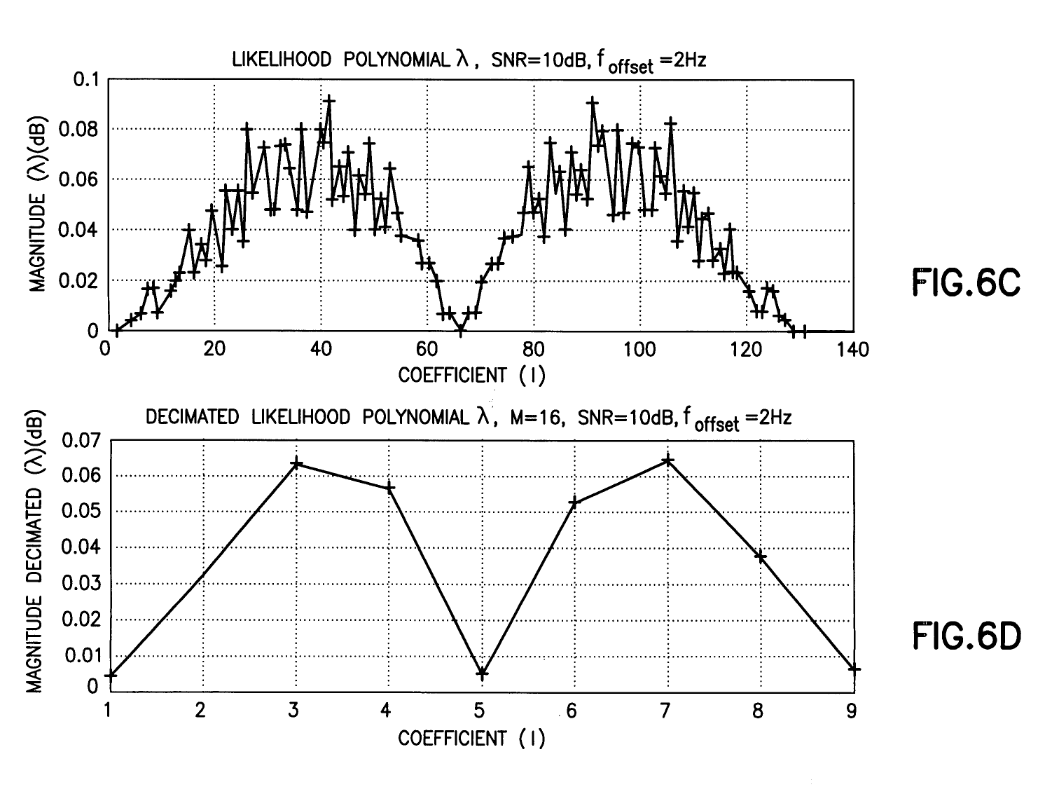

The same case is used as described in Table 1 with the new parameter being the decimation factor V=16 (see FIG. 5). With a frequency offset fᵣ=2 Hz a good mle of thumb for the decimation factor is V≦fₛ/2fᵣ=128/4=32. when decimation factors are chosen within this limit. FIG. 6 shows the frequency and phase response for a low pass decimation filter for decimation factor V=16. The cut-off frequency is ≈4 Hz, which gives a flat frequency response and linear phase at 2 Hz frequency offset. A decimation factor of V=32 may result in the frequency offset being too close to the cut-off frequency of most filters, potentially severely degrading the content of the signal-of-interest. The zero-phase characteristic may be achieved by using the MATLAB function “resample”. The filter is formed using the Kaiser windowing method. For FIR decimation filters that do not have excellent flat passband frequency response characteristics like the Kaiser windowing technique, it is necessary to use smaller decimation factors to get flatter passband response over a wider passband frequency response interval. Unfortunately smaller decimation factors introduce additional frequency spectral nulls thus more computational complexity for root-finding. For practical implementations, the decimation filter is preferably designed to accommodate the maximum expected frequency offset.

FIG. 6 shows the magnitude of the coefficients of the likelihood polynomial for both un-decimated and decimated cases. There are 2(Nₗ+Nₘ−1)=130 coefficients in the un-decimated likelihood polynomial in the upper plot. The lower plot shows the decimated likelihood polynomial which has 9 coefficients as a consequence of down-sampling by V=16. The decimated coefficients show the same symmetry characteristics as the un-decimated coefficients near the middle of the sequence with 9 coefficients capturing the characteristics of a frequency offset of 2 Hz.

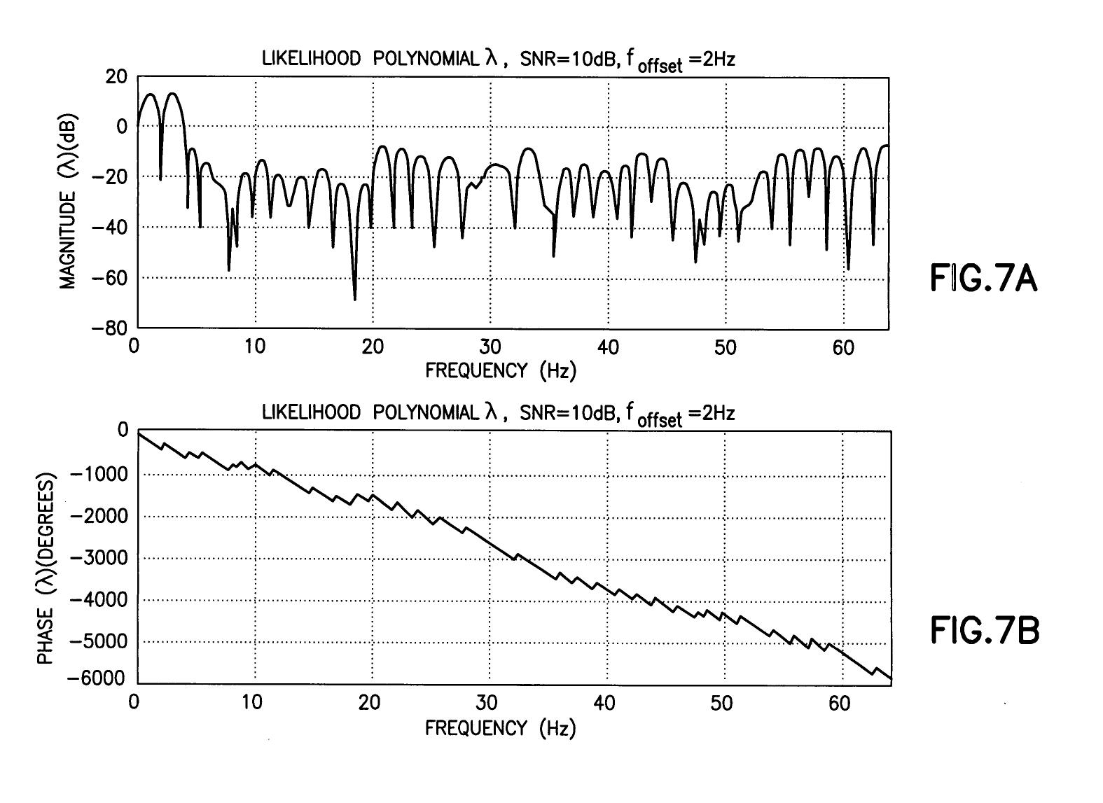

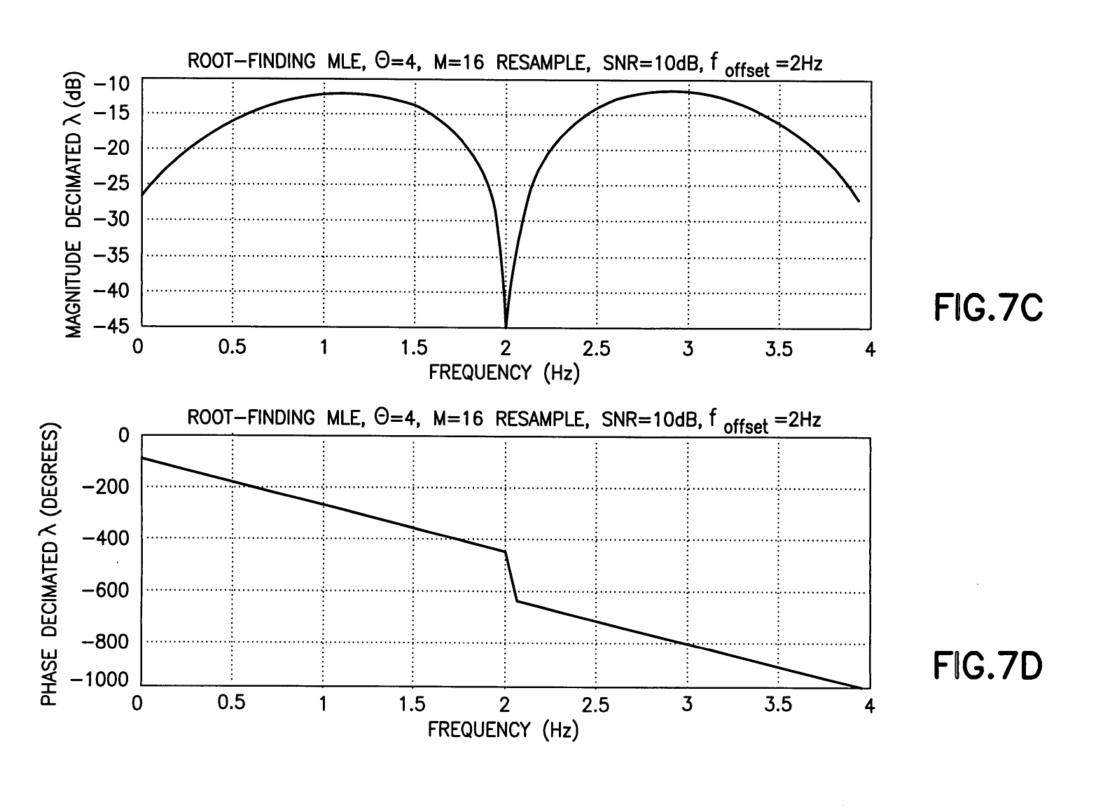

FIG. 7 shows the frequency response of both magnitude and phase of un-decimated and decimated likelihood polynomials. There is a noticeable “null” in the frequency response below 10 Hz in the un-decimated polynomial but also notice other numerous “nulls” at other locations above 10 Hz up to fₛ/2=64 Hz. These other locations represent “zeros” in the polynomial that are locations of frequency offset candidates for the likelihood surface search grid. For the un-decimated polynomial, the time computational complexity of the likelihood search would be dominated by finding roots that are not good candidates to minimize the likelihood polynomial and in some cases these roots could cause false extrema on the likelihood surface. FIG. 7 also shows the frequency response of both magnitude and phase of a decimated likelihood polynomial. Due to filtering and down-sampling the new sampling frequency for the decimated polynomial is 8 Hz. The frequency response is shown out to cut-off frequency of 4 Hz for the signal passband. There is a noticeable “null” at frequency offset of 2 Hz. This is a potential root of the decimated likelihood polynomial. Notice there are no other nulls in the frequency response for the positive frequencies. The time computational complexity would thus not be dominated by finding roots that are not good candidates to minimize the likelihood polynomial.

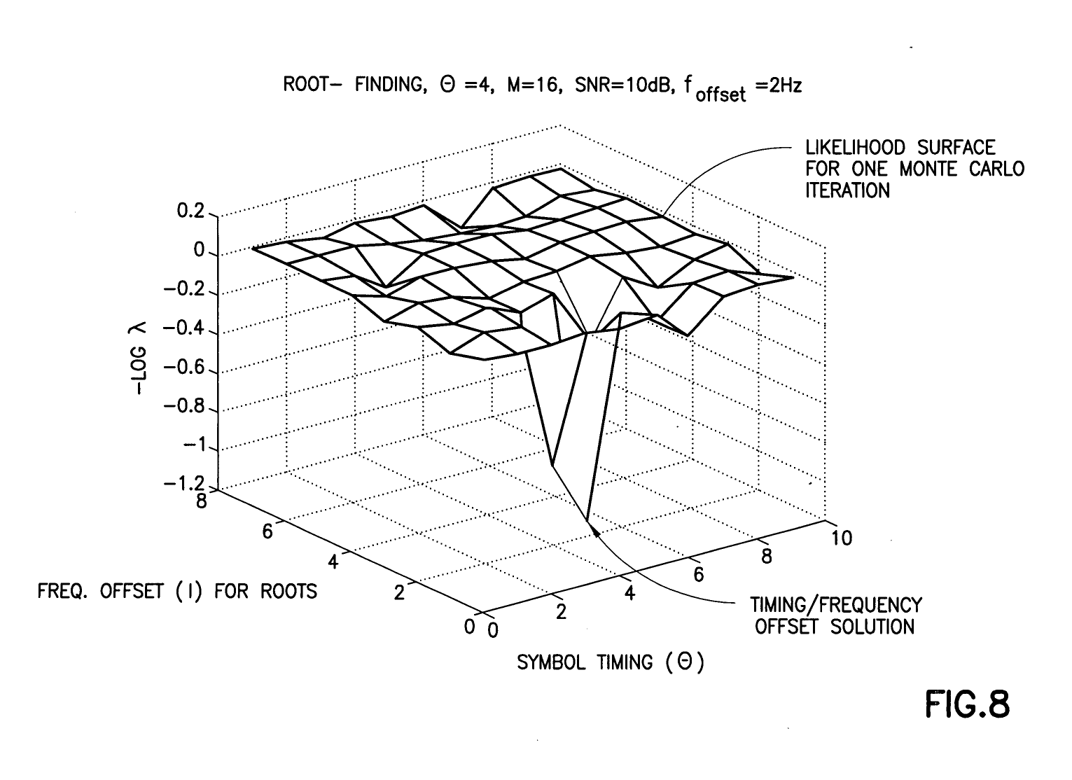

FIG. 8 shows the log-likelihood surface for the search over phase and frequency offset for a typical Monte Carlo run for a decimated likelihood polynomial (see FIG. 2) for the corresponding case for un-decimated polynomial. The surface is computed over 10 symbol timing offsets θ for both cases. The roots computed from the likelihood polynomial are stored in a vector in no particular order. For each hypothesized symbol offsets θₖ, k=0, 1, . . . , 9 the roots are computed from the likelihood polynomial. There are 130 roots computed for each θₖ in FIG. 2, but 9 roots computed for each θₖ for decimated likelihood. (Note that the total number roots includes all minimum and maximum for the likelihood polynomial and the negative frequency axis which is not shown.) The likelihood surface minimum (thus MLE) is found over a much smaller set of points on the log-likelihood surface. For this Monte Carlo run \hat{θ}=4 ,\hat{f}ᵣ≈2 Hz.

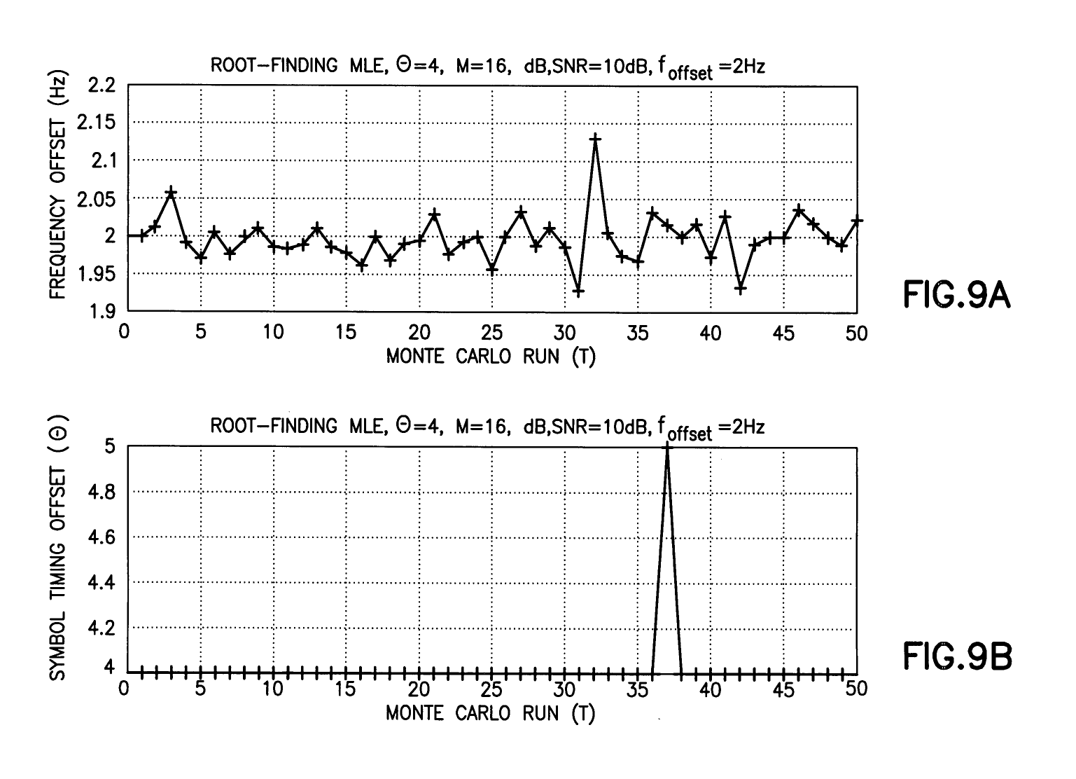

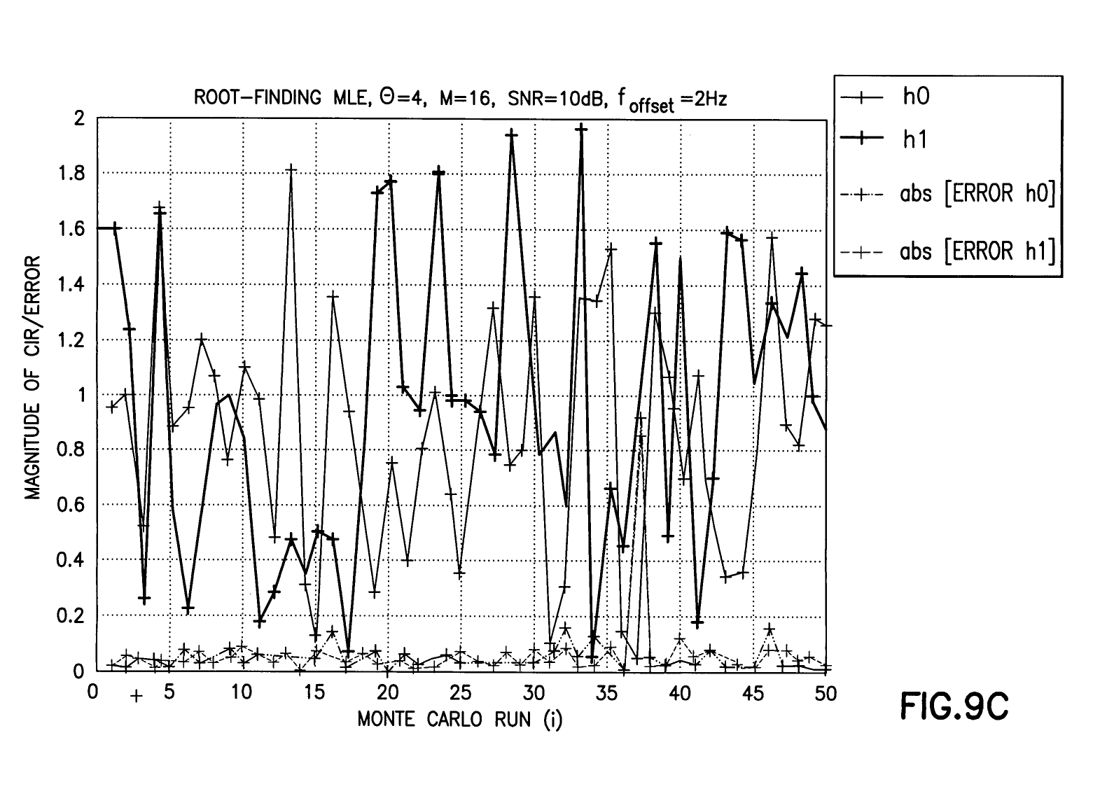

FIG. 9 shows frequency and symbol timing offset estimates for 50 Monte Carlo runs. Frequency offset estimates are in good agreement with the actual frequency offset of 2 Hz. The phase offset estimates coincide with the actual phase offset of θ=4 time epochs except for Monte Carlo run (i.e. 37) where \hat{θ}=5 time epochs. These results compare favourably with results in FIG. 3 for an un-decimated likelihood polynomial. FIG. 9 also shows the corresponding CIR for the 2-tap channel using decimated likelihood polynomial. As shown the estimation error is quite small relative to the magnitude of the channel coefficients. The magnitude of the error terms are similar to the case of frequency and symbol timing offset estimation using an un-decimated polynomial.

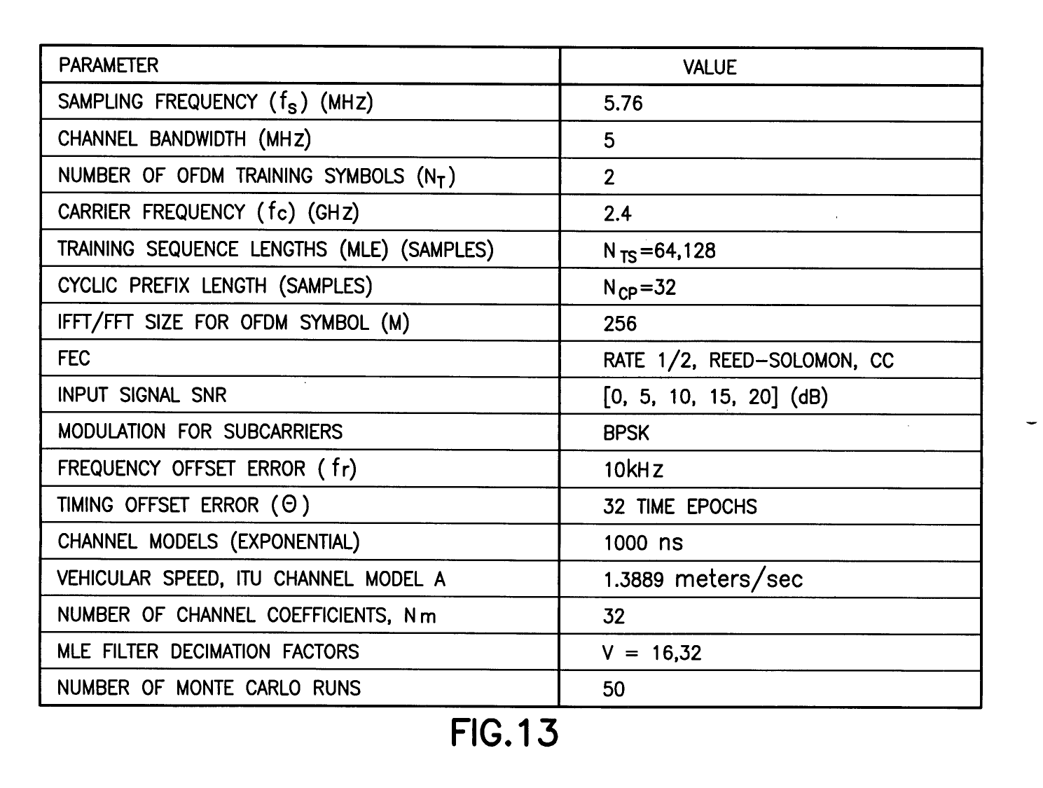

A discussion is now made of the performance with the IEEE 802.16e preamble structure. FIG. 13 shows typical IEEE 802.16e configuration parameters for an OFDM waveform for a downlink packet structure. More specifically, the Table shows the preamble structure for OFDM packets, wherein synchronization methods that use the sequential structure of the training symbols are denoted as legacy synchronization algorithms. Details of typical and practical synchronization algorithms can be found in U. Mengali and A. N. D'Andrea, Synchronization Techniques for Digital Receivers, Plenum Press, New York, 1997, and in Juha Heiskala and John Terry, OFDM Wireless LANs: A Theoretical and Practical Guide, Sams Publishing, 2002.

Discussed now is the performance of the MLE using one OFDM symbol for synchronization.

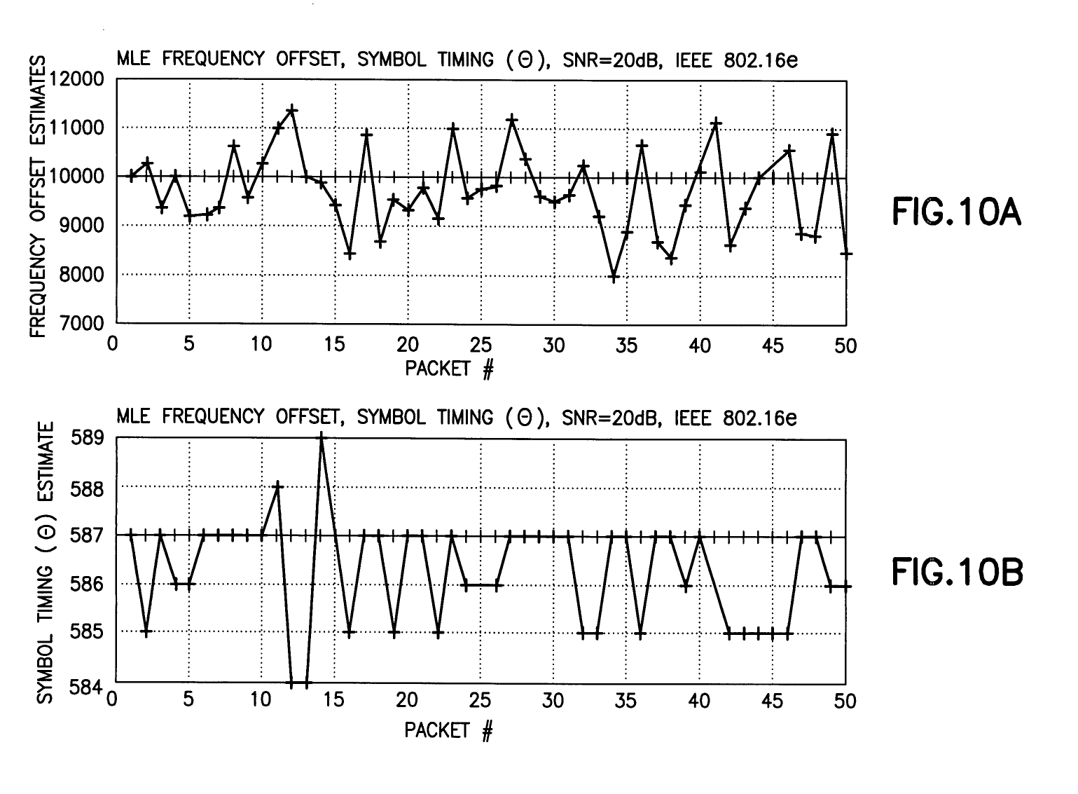

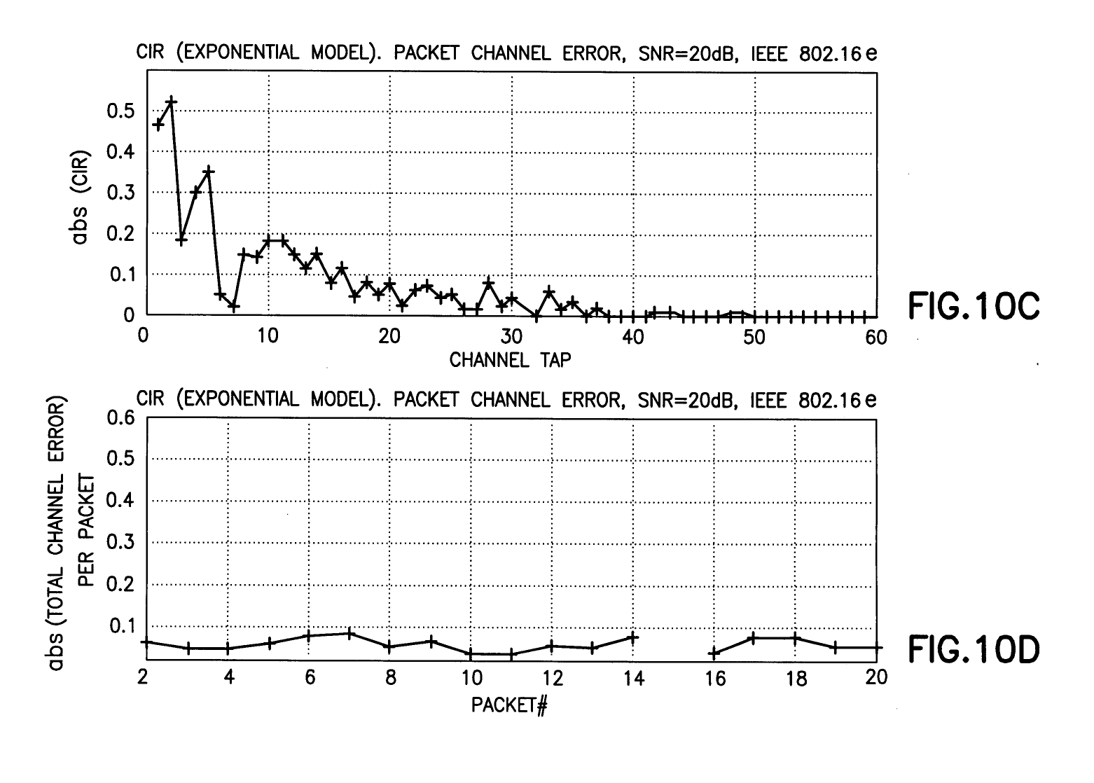

FIG. 10 shows frequency and symbol timing estimates for 50 OFDM packets compared to actual frequency and symbol timing offsets at SNR=20 dB. An exponential channel tapped delay line model is used to model fading. The true frequency offset is 10 kHz and true symbol timing offset is time sample 587 in a packet. However it is possible to synchronize if symbol timing offset is <587 due to cyclic prefix and cyclic properties of the DFT.

FIG. 10 also shows the magnitude of a typical channel delay profile over 1 OFDM symbol for an exponential channel model with 1 μsec delay profile. Notice that the CIR extends beyond the cyclic prefix length of 32 channel taps. Also included is the computed total channel error between the CIR and the channel estimates for each tap for each OFDM symbol for 20 different instances of training symbols. The total error (e) is computed by

$$e = \sqrt{{\sum }_{n = 0}^{{N}_{IFFT} - 1} {‖ H ( n ) - \hat{H} ( n ) ‖}^{2}}$$

where H(n), Ĥ(n) are actual FFTs of the CIR and estimated CIR respectively for N_{IFFT}=256. The error (e) can be computed in the frequency or time domain. The MLE estimates 32 taps of the cyclic prefix which implies there is a residual channel estimation error due to the actual channel taps beyond the cyclic prefix length as shown. The maximum total error term over all taps is ≠(5-10)% of the maximum tap value as shown.

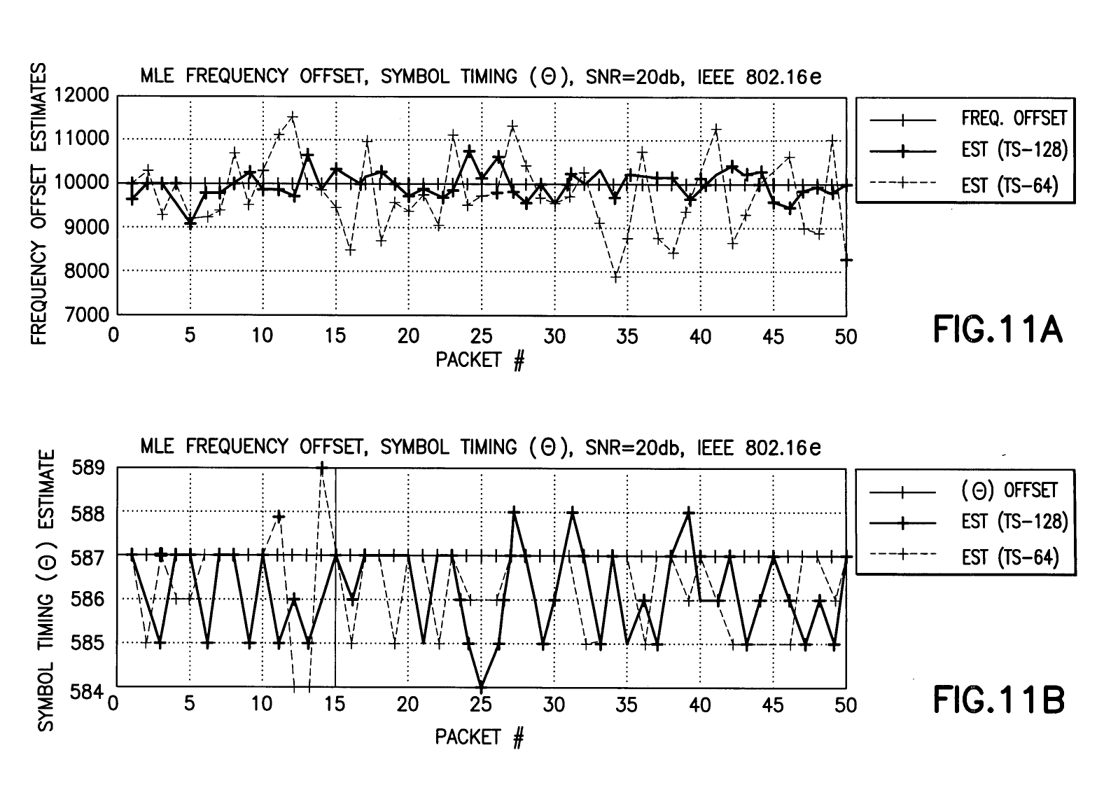

FIG. 11 shows a comparison of frequency and symbol time offsets for 2 training sequences of different lengths at SNR=20 dB. The training sequence lengths (N_{TS}) in time samples are N_{TS}=64,128. Training sequence length N_{TS}=64 was selected to reflect the one of short training sequences used for frequency offset estimation in the first OFDM training symbol in a packet burst. However with MLE, the short training sequence in the first OFDM training symbol is used for jointly estimating all synchronization parameters. The second OFDM symbol is not used. The upper plot shows a significant improvement in frequency offset estimation when increasing the training samples from N_{TS}=64 to N_{TS}=128 . The estimation statistics are summarized below in Table 2 which shows at least 2 fold improvement in standard deviation of frequency offset error from σ_{f}_{ᵣ}=808 Hz for N_{TS}=64 to σ_{f}_{ᵣ}=303 Hz for N_{TS}=128. The means for both cases do not vary as much. For MLE symbol timing offset is determined by using the estimated symbol timing offset which should be ideally time sample 33. FIG. 1 shows that the data bearing symbols start 2 OFDM symbols later which means the start of data symbols (tₛ=2×(256+32)=576). (In the simulation set-up, the first 10 samples before the start of the CP were searched which gives a starting time at 587 for data.) The symbol timing offsets show very little difference in statistics, however there are three synchronization errors.

TABLE 2
IEEE 802.16e Summary Statistics

| | N_{TS} = 64 | N_{TS} = 128 |
|---|---|---|
| Std. (\hat{f}ᵣ) Hz | 870.9146 | 455.5345 |
| ean (\hat{f}ᵣ) Hz | 9,901.3 | 9,895.6 |
| Std. (\hat{θ}) | 1.0150 | 1.1250 |
| Mean (\hat{θ}) | 586.5200 | 586.1400 |
| Median (\hat{θ}) | 587 | 586 |
| % Synchronization | 96 | 94 |

Using a standard student's t—distribution test with (n−1) degrees of freedom of the frequency offset estimate mean f̅ᵣ (see A. M. Mood, F. A. Graybill and D. C. Boes, Introduction to the Theory of Statistics: Third Edition, McGraw-Hill, Inc., 1974) yields a passing test for frequency offset estimation. A more accurate statistical test of the mean would use the sign test for medians (see J. D. Gibbons, Nonparametric Statistical Inference: Second Edition, Revised and Expanded, Marcel Dekker, Inc., 1985). This test is non-parametric while the student's t—distribution test assumes a Gaussian pdf for the estimation statistics. However the sign test also passed for both training sequences. There is an expected improvement in the standard deviation statistics with larger number of samples used in the training sequence. This reduces the amount of residual frequency offset remaining for phase tracking that continues with data bearing OFDM symbols in a burst packet. Unbiased estimates also imply that the Fisher information matrix can be used to determine the best possible estimation error (see H. L. Van Trees, Detection, Estimation and Modulation Theory: Part I, John Wiley and Sons, New York, N.Y., Chapter 2, 1968).

Discussed now is the bi-variate root-likelihood embodiments. More specifically, this discussion concerns extensions of the root-finding technique to bi-variate root finding. This eliminates the need to do any brute-force searching to determine valid symbol-timing and frequency-offset tuples for the likelihood equation. The approach is based on the PRIME algorithm (see J. Ward and G. F. Hatke, An Efficient Rooting algorithm for simultaneous angle and Doppler estimation with space-time adaptive processing radar, 1997. Conference Record of the Thirty-First Asilomar Conference on Signals, Systems & Computers, Volume: 2 , 2-5 Nov. 1997, pp. 1215-1218 vol. 2 and G. F. Hatke and K. W. Forsythe, A class of polynomial rooting algorithms for joint azimuth/elevation estimation using multidimensional arrays, 1994 Conference Record of the Twenty-Eighth Asilomar Conference on Signals, Systems and Computers, Volume: 1, 31 Oct.-2 Nov. 1994, pp. 694-699, vol. 1) and more fundamentally uses the properties of the resultants of polynomials (see R. Lidl and H. Neiderreiter, Finite Fields, Cambridge University Press, 1997 and B. L. van der Waerden, Modern Algebra, Vol. I and II, Ungar, New York 1953). The original motivation for using the PRIME algorithm for bi-variate polynomial root-finding was in the radar community. The 2-dimensional direction-of-arrival problem for a signal impinging on a planar signal array could be cast as finding the solution to two simultaneous equations in two polynomials
g₁(u,ω)=0
g₂ (u,ω)=0 (19)
where the direction of arrival information is embedded in the terms

$$u {=}^{Δ} exp [ j \frac{{d}_{x} ϖ}{c} {ζ}_{u} ] \\ w {=}^{Δ} exp [ j \frac{{d}_{y} ϖ}{c} {ζ}_{w} ] , \qquad ( 20 )$$

where dₓ,d_{y} are spacing between sensor elements in the ω̅ plane, the term u is the frequency of radiation of the received signal in radians per second, and c is the speed of propagation of the waves in the medium. The terms ζᵤ, ζ_{w} are related to the direction cosines of the signal which are the parameters of interest. In G. F. Hatke and K. W. Forsythe, A class of polynomial rooting algorithms for joint azimuth/elevation estimation using multidimensional arrays, 1994 Conference Record of the Twenty-Eighth Asilomar Conference on Signals, Systems and Computers, Volume: 1, 31 Oct.-2 Nov. 1994, pp. 694-699, vol. 1, there is used bi-variate root-finding for the approximate ML solution for direction-of-arrival estimation. While the current problem of interest is different in formulation, there are certain similarities to the prior problem that can be exploited. The starting point for bi-variate root-finding is to first consider two polynomials f(x) and g(x) of a single variable with complex coefficients
f(x)=aₙxⁿ+ . . . +a₁x¹+a₀
g(x)=bₘx^{m}+ . . . +b₁x¹+b₀ (21)
and let {γᵢ} and {δᵢ} denote the roots of f,g respectively, then the resultant (see B. L. van der Waerden, Modern Algebra, Vol. I and II, Ungar, N.Y. 1953) of the two polynomials is given by

$$R ( f , g ) {=}^{Δ} {a}_{n}^{m} {b}_{m}^{n} {\prod }_{i , q} ( {γ}_{i} - {δ}_{q} ) . \qquad ( 22 )$$

It can also be shown that R(f,g) (i.e. resultant) is a polynomial in coefficients {aᵢ},{b_{q}} of the polynomials f,g that vanishes if and only if f(x) and g(x) have a common root. The resultant can also be defined, due to Sylvester, in terms of {aᵢ},{b_{q}} as the determinant of an (m+n)×(m+n) matrix

$$R ( f , g ) = det \{ [ \begin{matrix}{a}_{n} & {a}_{n - 1} & … & {a}_{0} & 0 & … & 0 \\ 0 & {a}_{n} & {a}_{n - 1} & … & {a}_{0} & … & 0 \\ ⋮ & & & & & & ⋮ \\ 0 & … & 0 & {a}_{n} & … & {a}_{1} & {a}_{0} \\ {b}_{m} & {b}_{m - 1} & … & {b}_{0} & 0 & … & 0 \\ 0 & {b}_{m} & {b}_{m - 1} & … & {b}_{0} & … & 0 \\ ⋮ & & & & & & ⋮ \\ 0 & … & 0 & {b}_{m} & … & {b}_{1} & {b}_{0}\end{matrix} ] \} \qquad ( 23 )$$

Now if f,g are bi-variate polynomials then each polynomial can be considered as a polynomial in one term with coefficients in terms of the other. For example:
f(u,w)=_{0.0}+a_{1.0}u+a_{1.1}uw+a_{0.1}w=(a_{0.0}+a_{1.0}u)+(a_{1.1}u+a_{0.1})w=A₀(u)+A₁(u)w (24)
which is now a polynomial in w with coefficients that are functions of u. The resultant R(f,g) becomes a function of u or

$${R}_{u} ( f ( u , w ) , g ( u , w ) ) = det \{ [ \begin{matrix}{A}_{n} ( u ) & {A}_{n - 1} ( u ) & … & {A}_{0} ( u ) & 0 & … & 0 \\ 0 & {A}_{n} ( u ) & {A}_{n - 1} ( u ) & … & {A}_{0} ( u ) & … & 0 \\ ⋮ & & & & & & ⋮ \\ 0 & … & 0 & {A}_{n} ( u ) & … & {A}_{1} ( u ) & {A}_{0} ( u ) \\ {B}_{m} ( u ) & {B}_{m - 1} ( u ) & … & {B}_{0} ( u ) & 0 & … & 0 \\ 0 & {B}_{m} ( u ) & {B}_{m - 1} ( u ) & … & {B}_{0} ( u ) & … & 0 \\ ⋮ & & & & & & ⋮ \\ 0 & … & 0 & {B}_{m} ( u ) & … & {B}_{1} ( u ) & {B}_{0} ( u )\end{matrix} ] \} \qquad ( 25 )$$

Letting Rᵤ(f(u,w),g(u,w))=0 yields a polynomial whose roots uᵢ are common to both f,g. Likewise R_{w}(f(u,w),g(u,w)) can be formed by collecting terms in each bi-variate polynomial in u. Letting R_{w}(f(u,w),g(u,w))=0 yields a polynomial whose roots wₗ are also common to both f,\dot{g}. These roots uᵢ,wₗ are then solutions in both f(uᵢ,wₗ)=0 and g(uᵢ,wₗ)=0.

As previously noted, searching over a 2-D grid in θ,ω is necessary to find candidate solutions for log-likelihood. The maximum of log-likelihood over θ,ω determines joint solution for CIR (i.e. hᵢ) and θ,ω. It turns out that both derivative equations (9) are in a simple form by making a further substitution (in each individual term). For example, equation (15) for

$$\frac{\partial Λ}{\partial ω} = 0$$

can be expressed in a bi-variate polynomial form with a substitution s(ρ−θ)=F(exp{jθ}). The DFT is an example of such a Substitution. which yields

$$\begin{matrix}s ( ρ - l - θ ) = \frac{1}{\sqrt{G}} {\sum }_{τ = 0}^{G - 1} S ( τ ) {ⅇ}^{\frac{j2π ( ρ - l - θ ) τ}{G}} \\ = \frac{1}{\sqrt{G}} {\sum }_{τ = 0}^{G - 1} S ( τ ) {ⅇ}^{\frac{j2π ( ρ - l ) τ}{G}} {ⅇ}^{\frac{- j2π0τ}{G}}\end{matrix}$$

and likewise

$$s ( v - l - θ ) = \frac{1}{\sqrt{G}} {\sum }_{τ = 0}^{G - 1} S ( τ ) {ⅇ}^{\frac{j2π ( v - l ) τ}{G}} {ⅇ}^{\frac{- j2π0τ}{G}} .$$

Now equation (15) can be written as

$$\frac{\partial {Λ}^{′}}{\partial ω} = f ( u , w ) = 0 , u = {ⅇ}^{j2πω T} , w = {ⅇ}^{j2πθ / G} \qquad ( 26 )$$

Likewise

$$\frac{\partial {Λ}^{′}}{\partial θ} = g ( u , w ) = 0 , u = {ⅇ}^{j2πω T} , w = {ⅇ}^{j2πθ / G} \qquad ( 27 )$$

where

$$\begin{matrix}\frac{\partial {Λ}^{′}}{\partial θ} = \frac{\partial \{ - ln Λ ( {Z}_{N} \vert θ \cdot ω \cdot h ) \}}{\partial θ} \\ = - \{ \begin{matrix}{\sum }_{ρ = 0}^{{θ}_{MAX} + N - 1} \frac{\partial }{\partial θ} \{ {B}_{ρ} ( θ , ω ) \} {k}_{ρ} {z}_{ρ}^{*} + \\ {\sum }_{ρ = 0}^{{θ}_{MAX} + N - 1} \frac{\partial }{\partial θ} \{ {B}_{ρ}^{*} ( θ , ω ) \} {k}_{ρ}^{*} {z}_{ρ}\end{matrix} \}\end{matrix} \qquad ( 28 )$$

with

$$\{ {B}_{ρ} ( θ , ω ) \} and \frac{\partial }{\partial θ} \{ {B}_{ρ} ( θ , ω ) \}$$

defined in equations (I1) and (12), respectively.

With the bi-variate polynomial representation of the likelihood polynomials, the MLE for θ,ω and h is formed as follows (refer to FIGS. 5 and 6):
1) Form f(u,w),g(u,w) using equations (26), and (27), respectively (block 605);
2) Form resultants Rᵤ(f(u,w),g(u,w)) and R_{w}(f(u,w),g(u,w)) (see equation 25) (block 610);
3) Solve for roots uᵢ,wₗ from Rᵤ(f(u,w),g(u,w))=0 and R_{w}(f(u,w),g(u,w))=0, respectively (block 615);
4) Determine ωᵣ in uᵣ=e^{jωT} (block 620) and θₗ in wₗ=e^{j2πθ/G} (block 630);
5) Compute

$${\hat{h}}_{i , r , l} = \frac{1}{{N}_{l} {σ}_{s}^{2}} {\sum }_{ρ = {θ}_{l} + i}^{{θ}_{l} + i + {N}_{l} - 1} {z}_{ρ} {s}^{*} ( ρ - {θ}_{l} - i ) {k}_{ρ , r}^{*} , i = 0 , 1 , … , {N}_{m} - 1$$

using k_{ρ,r}=e^{jω}^{ᵣ}^{ρT} (block 520);
6) Compute μ_{ρ,i,r,l} in equation (7) using (θₗ,ωᵣ,ĥ_{i,r,l}) (block 525);
7) Evaluate the log-likelihood function in equation for all tuples of roots (θₗ,ωᵣ,ĥ_{i,r,l}) using equation (8) (block 530);
8) The symbol timing-offset, frequency-offset error and channel estimate is determined as the tuple (θₗ,ωᵣ,h_{i,r,l}) which minimizes the log-likelihood function (block 535)

$$( \hat{u} , \hat{θ} , \underline{\hat{h}} ) = {min}_{( {θ}_{l} , {ω}_{r} , {h}_{r , l} )} \{ - ln Λ ( {Z}_{N} \vert θ , ω , \underline{h} ) \} .$$

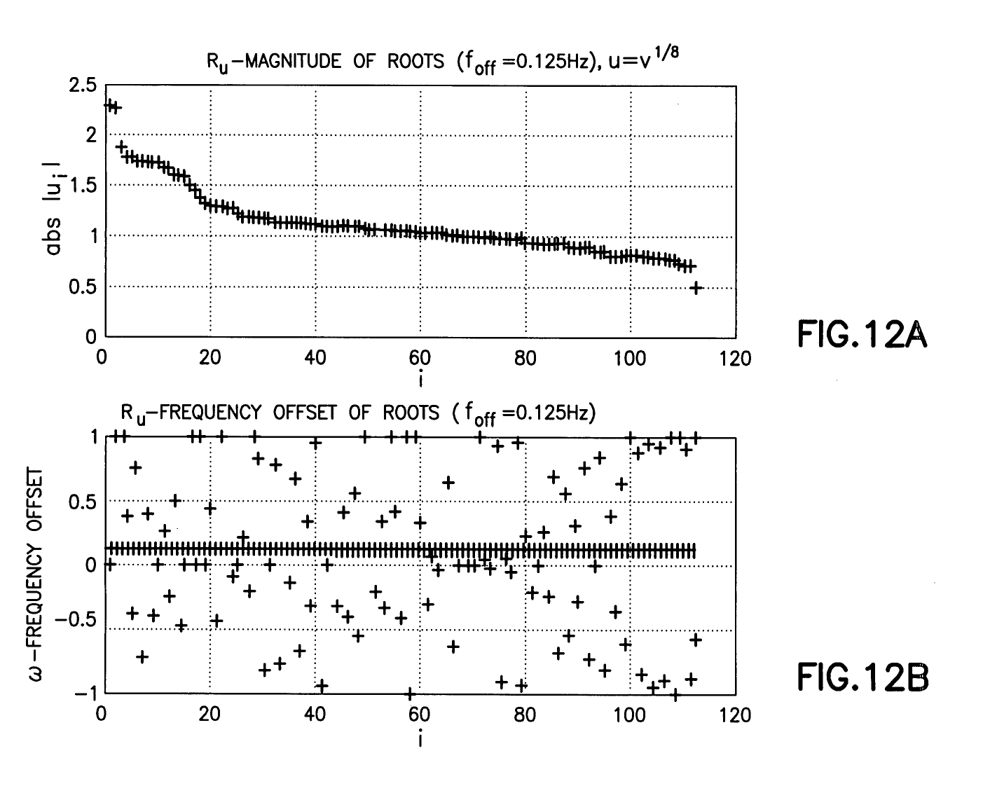

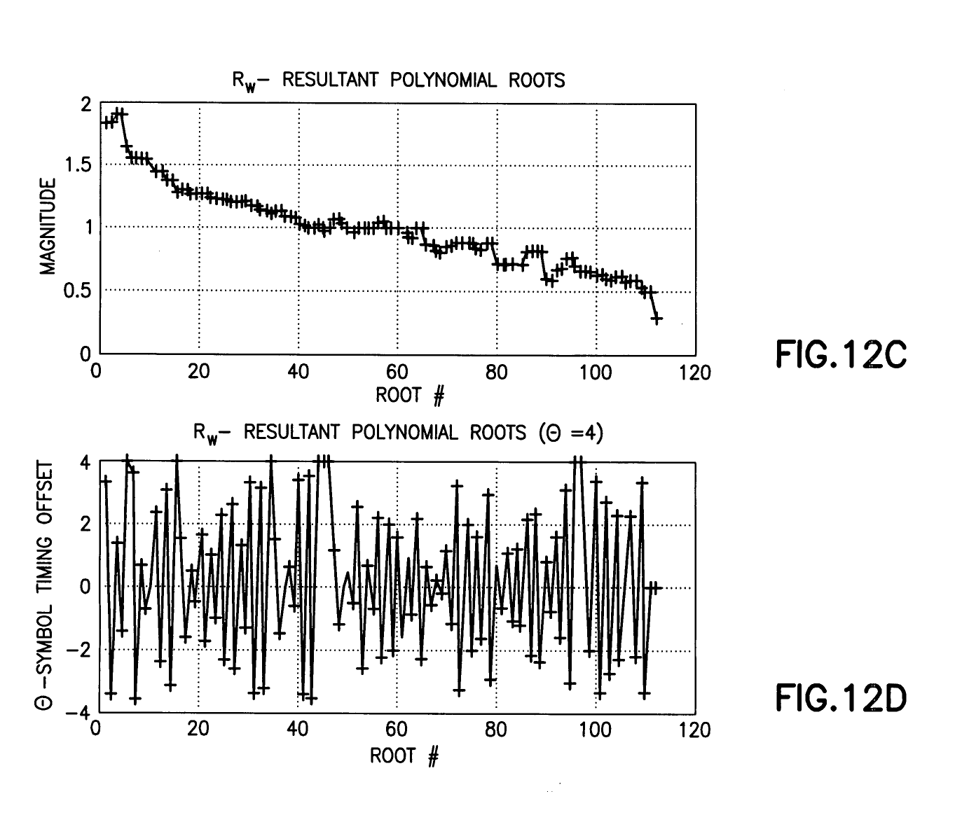

FIG. 12 shows an example of roots computed for a contrived, modest case for a very short training sequence of eight symbols, frequency offset (fᵣ=0.125 Hz) and symbol timing offset (θ=4) time epochs. Note that equation (25) can be determined using the computation of a symbolic determinant and the use of a program such as Mathematica to simplify the programming task. Unfortunately this is an interpretative language which is very slow computationally. (The computational time can be reduced using a hypothesized range of symbol-timing offsets limited by performing 2-D filtering and decimation over both frequency and symbol timing offset when the range of symbol timing offsets is known.) For this case over 100 roots were computed each for both frequency and symbol timing offset. This would result in over 10⁴ grid points. Since the magnitude of the roots for u,w should be near unity then further “pruning” can be performed to determine set of feasible roots for the likelihood search. For symbol timing offset (i.e. right plots) roots between indices (40-80) would be considered. For frequency offsets roots, roots for indices (20-80) would be considered. As shown, frequency offsets of 0.125 Hz and symbol timing offsets are included in the ranges. It should be noted that determinants may also be found using software or hardware configured to perform the determinant calculations.

The use of the exemplary embodiments of this invention allows one to perform joint channel estimation, frequency offset and symbol timing estimates in one OFDM symbol instead of using two OFDM symbols in the standard technique, or any technique, that uses sequential estimation for synchronization with OFDM preambles. The second OFDM symbol may be used for data. The use of the exemplary embodiments of this invention further enables one to improve on estimates of channel estimation, frequency offset and symbol timing estimates due to the MLE approach using the same number of samples as sequential approaches. The use of the exemplary embodiments of this invention also allows one to exploit the randomness of one training sequence to suppress interference from other base stations, while current legacy approaches do not perform as well for frequency offset estimation based on embedded periodic sequences in first OFDM symbol.

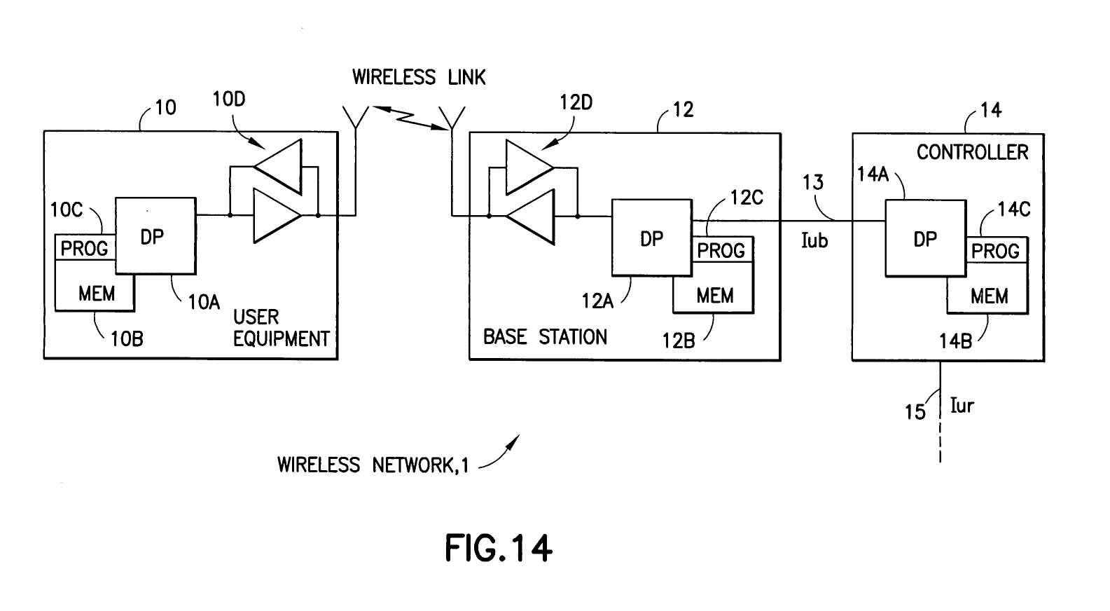

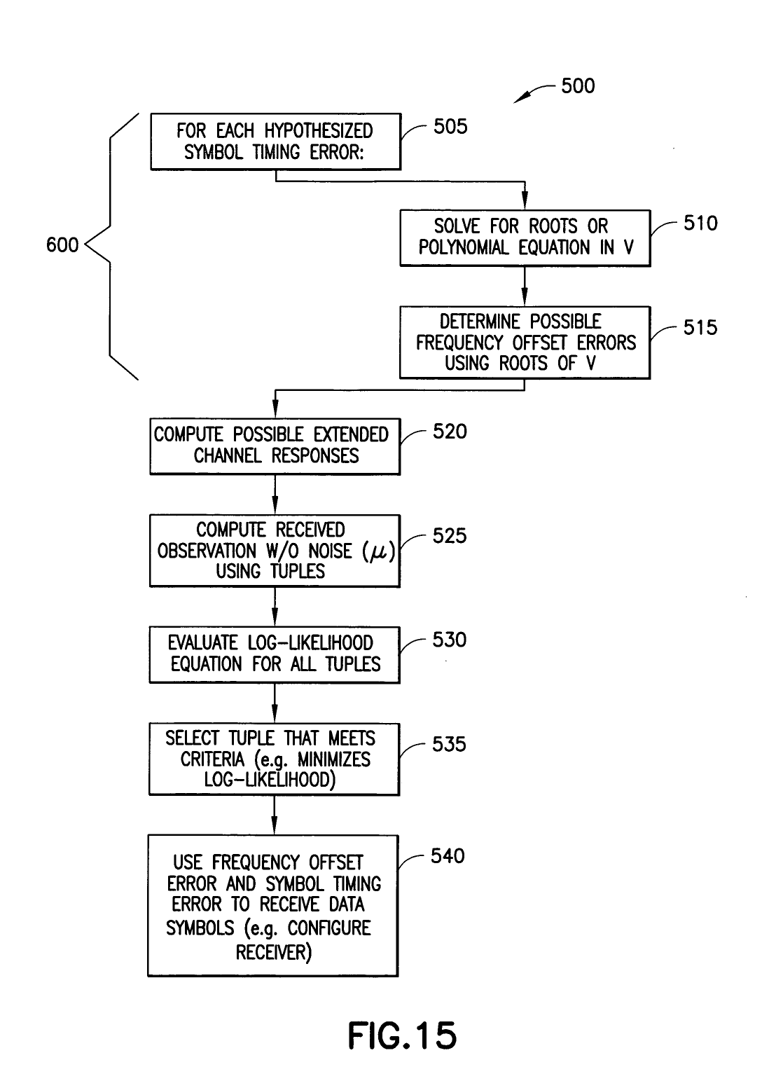

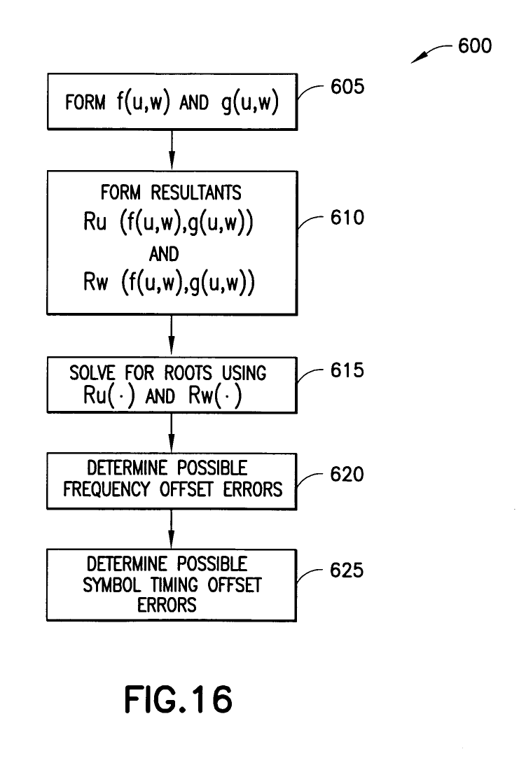

Reference is now made to FIG. 14 for illustrating a simplified block diagram of various electronic devices that are suitable for use in practicing the exemplary embodiments of this invention. In FIG. 14 a wireless network 1 is adapted for communication with a mobile device, referred to for convenience as a user equipment (UE) 10, via an access point, such as a base station (e.g., Node B) 12. The network 1 may include a radio resource management block, such as a controller (e.g., radio network controller, RNC) 14. The UE 10 includes a data processor (DP) 10A, a memory (MEM) 10B that stores a program (PROG) 10C, and a suitable radio frequency (RF) transceiver 10D for bidirectional wireless communications with the base station 12, which also includes a DP 12A, a MEM 12B that stores a PROG 12C, and a suitable RF transceiver 12D. The base station 12 is coupled, in the illustrated, non-limiting embodiment, via a data path 13 (Iub) to the controller 14 that also includes a DP 14A and a MEM 14B storing an associated PROG 14C. The controller 14 may be coupled to another controller (not shown) by another data path 15 (Iur). At least one of the PROGs 10C and 12C is assumed to include program instructions that, when executed by the associated DP, enable the electronic device to operate in accordance with the exemplary embodiments of this invention, as was discussed above.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of this invention may be implemented by computer software executable by the DP 10A of the UE 10 and the other DP 12 of the base station 12, or by hardware, or by a combination of software and hardware.

The MEMs 10B, 12B and 14B may be of any type suitable to the local technical environment and may be implemented using any suitable data storage technology, such as semiconductor-based memory devices, magnetic memory devices and systems, optical memory devices and systems, fixed memory and removable memory. The DPs 10A, 12A and 14A may be of any type suitable to the local technical environment, and may include one or more of general purpose computers, special purpose computers, microprocessors, digital signal processors (DSPs) and processors based on multi-core processor architectures, as non-limiting examples.

Based on the foregoing it should be apparent that the exemplary embodiments of this invention provide a method, apparatus and computer program product(s) that enable a reduction in search stage complexity of valid frequency offset points for the likelihood surface by using root-finding over downsampled likelihood polynomials for frequency-offset estimation. Search complexity is further reduced by exploiting the polynomial structure of the symbol-timing offset in the frequency domain to perform root-finding of a bi-variate polynomial to determine both frequency and symbol-timing recovery, a process that is shown above to further reduce the grid points of symbol and frequency offsets that are needed to generate the likelihood surface.

Based on the foregoing it should be further apparent that the exemplary embodiments of this invention provide a method, apparatus and computer program product(s) to estimate a channel. In one aspect thereof the exemplary embodiments of this invention enable root-finding by the use of the polynomial in equation (15), and the use of a method to compute the roots of such a polynomial. Assuming as well that the decimated form of the method is employed, the exemplary embodiments of this invention also encompass the use of a low-pass filter and a structure to perform “zero-phase” filtering to avoid biased solutions. The bi-variate root-finding method employs equations (26) and (27) as a starting point, and further utilize equation (25) to provide the resultant.

The exemplary embodiments of this invention may be used in mobile terminal products for, as non-limiting examples, WiMAX, 3.9 G and WLAN and base stations/access points. Further, standardizations, such as those for WiMAX, could specify the use of non-periodic preambles in the first OFDM symbol of a packet. Furthermore, and in a related manner, the second OFDM symbol may be specified as a data-bearing symbol instead of as a training symbol. The use of the exemplary embodiments of this invention may benefit mobile devices and terminals by providing higher performance in synchronization, thus improving packet error rate performance since a synchronization failure results in physical packet loss that, in turn, may degrade round trip times in various systems, such as WiMAX and 3.9 G systems, also called LTE or EUTRAN systems.

In general, the various embodiments may be implemented in hardware (e.g., special purpose circuits, logic), or software or any combination thereof. For example, some aspects may be implemented in hardware, while other aspects may be implemented in software (e.g., firmware) which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware (e.g., special purpose circuits or logic, general purpose hardware or controller or other computing devices), software, or some combination thereof.

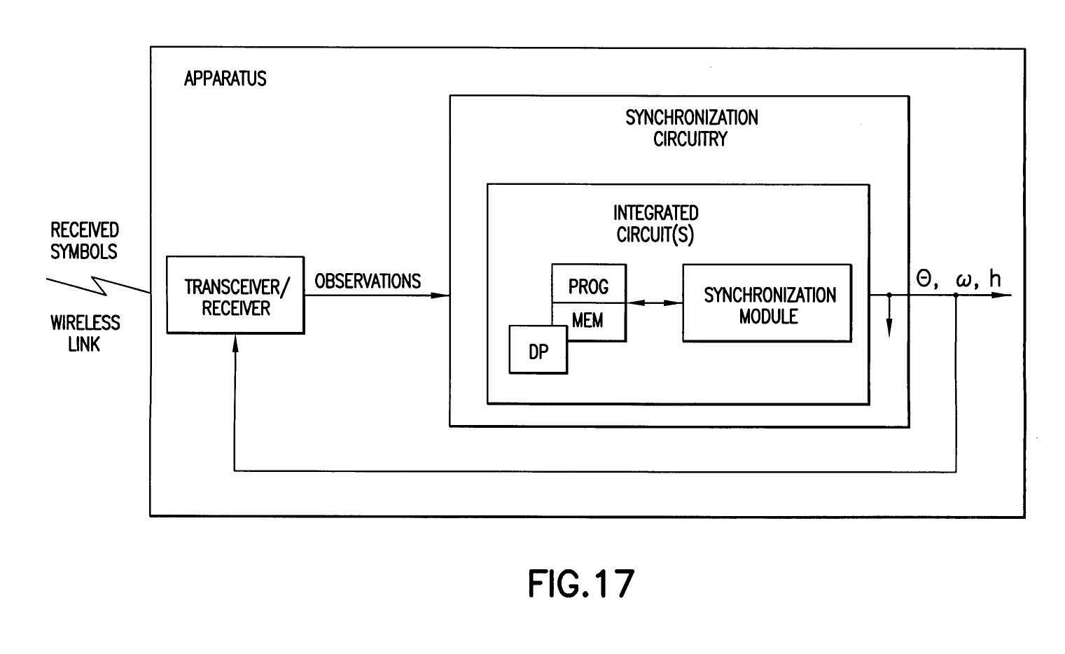

Embodiments of the invention, such as FIG. 5, may be practiced in various components such as integrated circuit modules. For instance, FIG. 17 shows a block diagram of an apparatus (e.g., UE 10 or base station 12 of FIG. 14) that includes a transceiver/receiver and synchronization circuitry. The transceiver/receiver receives received symbols over the wireless and creates observations of the received symbols (e.g., at associated times). The synchronization circuitry includes one or more integrated circuits. The one or more integrated circuits include a data processor associated with a memory having a program. The program includes instructions executable by the data processor and suitable for carrying out a portion of the exemplary embodiments of the disclosed invention. The one or more integrated circuits further comprise a synchronization module (e.g., a special purpose circuit) that also performs part of the exemplary embodiment of the disclosed invention. For instance, the determination of the determinants (block 615 of FIG. 6) might be implemented in the synchronization module to speed the determination process. There may be sharing of features of the disclosed invention between the data processor and associated memory and the synchronization module. There may be no synchronization module, such that the program would contain all the features disclosed herein. In another exemplary embodiment, there could be no program related to the synchronization disclosed herein, so that all features disclosed herein are incorporated into the synchronization module. It is noted that the synchronization circuitry may also include other (e.g., discrete) hardware elements not shown.

The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Various modifications and adaptations may become apparent to those skilled in the relevant arts in view of the foregoing description, when read in conjunction with the accompanying drawings. However, any and all modifications of the teachings of this invention will still fall within the scope of the non-limiting embodiments of this invention.

Furthermore, some of the features of the various non-limiting embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method, comprising:
determining a plurality of observations, each observation occurring at an observation time and corresponding to one of a plurality of received frequency multiplexed training symbols;
determining a plurality of roots of a first polynomial equation that is a function of a variable corresponding to frequency offset errors of carrier frequencies of the training symbols, wherein constants in the first polynomial equation are determined using at least the observations, and wherein the roots of the variable correspond to possible frequency offset errors;
based on at least the observations, the possible frequency offset errors, and possible symbol timing offset errors of the observation times of the training symbols, determining a plurality of estimated channel responses corresponding to the training symbols;
using a second polynomial equation that is a function of at least the estimated channel responses, the possible frequency offset errors, and the possible symbol timing offset errors, determining at least a resultant frequency offset error and a resultant symbol timing offset error; and
using the resultant frequency offset error and resultant symbol timing offset error in order to receive at least one frequency multiplexed data symbol.

2. The method of claim 1, wherein the first polynomial equation is formed using a partial derivative, with respect to the frequency offset error, of a logarithm of the second polynomial equation.

3. The method of claim 1, wherein determining at least a resultant frequency offset error and a resultant symbol timing offset error comprises finding a combination of one of the estimated channel responses, one of the possible frequency offset errors, and one of the possible symbol timing offset errors such that the combination causes a value corresponding to the second polynomial equation to meet at least one predetermined criterion.

4. The method of claim 3, wherein the value corresponding to the second polynomial equation is a value of a negative logarithm of the second polynomial equation and the at least one predetermined criterion is meeting a minimization of the values of the negative logarithm of the second polynomial equation.

5. The method of claim 1, wherein determining at least a resultant frequency offset error and a resultant symbol timing offset error comprises finding a combination of one of the estimated channel responses, one of the possible frequency offset errors, and one of the possible symbol timing offset errors that minimizes values of a negative logarithm of the second polynomial equation.

6. The method of claim 1, wherein:
the possible symbol timing offset errors comprise a plurality of hypothesized symbol timing offset errors;
the polynomial equation is also a function of the symbol timing offset error; and
determining a plurality of roots further comprises determining a set of roots of the polynomial equation for each of the hypothesized symbol timing offset errors, each set of roots comprising a plurality of roots.

7. The method of claim 6, wherein determining a plurality of roots of a first polynomial equation further comprises:
for each hypothesized symbol timing offset error, computing values corresponding to the first polynomial equation for each of the plurality of observations;
passing the computed values through a low pass, zero-phase filter to create filtered values;
decimating the filtered values to create decimated values;
forming a decimated version of the first polynomial equation from the decimated values; and
using the decimated version of the first polynomial equation to determine the plurality of roots.

8. The method of claim 6, wherein determining a plurality of estimated channel responses further comprises determining for each of the hypothesized symbol timing offset errors a set of estimated channel responses, each set of estimated channel responses comprising a plurality of estimated channel responses.

9. The method of claim 8, wherein determining at least a resultant frequency offset error and a resultant symbol timing offset error further comprises determining values corresponding to the second polynomial equation and to each of the sets of roots, the hypothesized symbol timing offset errors, and the set of estimated channel responses, and selecting a value of the determined values that meets at least one criterion, the selected value determining the resultant frequency offset error, the resultant symbol timing offset error, and a resultant plurality of channel responses.

10. The method of claim 1, wherein:
the plurality of roots of the first polynomial equation are first roots and the variable is a first variable; and
the method comprises determining a second plurality of roots of a third polynomial equation that is a function of a second variable corresponding to symbol timing offset errors of the observation times of the training symbols, wherein constants in the third polynomial equation are determined using at least the observations, and wherein the roots of the second variable correspond to the possible symbol timing offset errors.

11. The method of claim 10, wherein determining the first plurality of roots comprises determining a determinant of a matrix corresponding to the first polynomial equation and determining the second plurality of roots comprises determining a determinant of a matrix corresponding to the second polynomial equation.

12. An apparatus comprising:
synchronization circuitry coupleable to a receiver and configured to receive from the receiver information corresponding to a plurality of observations, each observation occurring at an observation time and corresponding to one of a plurality of received frequency multiplexed training symbols, the synchronization circuitry configured to determine a plurality of roots of a first polynomial equation that is a function of a variable corresponding to frequency offset errors of carrier frequencies of the training symbols, wherein constants in the first polynomial equation are determined using at least the observations, and wherein the roots of the variable correspond to possible frequency offset errors, the synchronization circuitry further configured, based on at least the observations, the possible frequency offset errors, and possible symbol timing offset errors of the observation times of the training symbols, to determine a plurality of estimated channel responses corresponding to the training symbols, the synchronization circuitry also configured, using a second polynomial equation that is a function of at least the estimated channel responses, the possible frequency offset errors, and the possible symbol timing offset errors, to determine at least a resultant frequency offset error and a resultant symbol timing offset error, and the synchronization circuitry configured to cause the receiver to use the resultant frequency offset error and resultant symbol timing offset error in order to receive at least one frequency multiplexed data symbol.

13. The apparatus of claim 12, further comprising the receiver coupled to the synchronization circuitry.

14. The apparatus of claim 12, wherein the synchronization circuitry is formed at least in part on a portion of one or more integrated circuits.

15. The apparatus of claim 12, wherein the synchronization circuitry is formed at least in part from at least one data processor and at least one associated memory, the at least one associated memory comprising a set of instructions executable by the at least one data processor.

16. The apparatus of claim 12, wherein the apparatus includes one or more of the following: a cellular telephone; a personal digital assistant having wireless communication capabilities; a portable computer having wireless communication capabilities; an image capture device having wireless communication capabilities; a gaming device having wireless communication capabilities; a music storage and playback appliance having wireless communication capabilities; an Internet appliances permitting wireless Internet access and browsing.

17. The apparatus of claim 12, wherein the apparatus includes a base station configured to communicate with at least one user equipment.

18. The apparatus of claim 12, wherein the first polynomial equation is formed using a partial derivative, with respect to the frequency offset error, of a logarithm of the second polynomial equation.

19. The apparatus of claim 12, wherein the synchronization circuitry is further configured, when determining at least a resultant frequency offset error and a resultant symbol timing offset error, to find a combination of one of the estimated channel responses, one of the possible frequency offset errors, and one of the possible symbol timing offset errors such that the combination causes a value corresponding to the second polynomial equation to meet at least one predetermined criterion.

20. The apparatus of claim 12, wherein the synchronization circuitry is further configured, when determining at least a resultant frequency offset error and a resultant symbol timing offset error, to find a combination of one of the estimated channel responses, one of the possible frequency offset errors, and one of the possible symbol timing offset errors that minimizes values of a negative logarithm of the second polynomial equation.

21. The apparatus of claim 12, wherein:
the possible symbol timing offset errors comprise a plurality of hypothesized symbol timing offset errors;
the polynomial equation is also a function of the symbol timing offset error; and
the synchronization circuitry is further configured, when determining a plurality of roots, to determine a set of roots of the polynomial equation for each of the hypothesized symbol timing offset errors, each set of roots comprising a plurality of roots.

22. The apparatus of claim 21, wherein the synchronization circuitry further comprises a low pass, zero-phase filter, and the synchronization circuitry is further configured, when determining a plurality of roots of a first polynomial equation, to compute, for each hypothesized symbol timing offset error, values corresponding to the first polynomial equation for each of the plurality of observations, to pass the computed values through a low pass, zero-phase filter to create filtered values, to decimate the filtered values to create decimated values, to form a decimated version of the first polynomial equation from the decimated values, and to use the decimated version of the first polynomial equation to determine the plurality of roots.

23. The apparatus of claim 12, wherein:
the plurality of roots of the first polynomial equation are first roots and the variable is a first variable; and
the synchronization circuitry is further configured to determine a second plurality of roots of a third polynomial equation that is a function of a second variable corresponding to symbol timing offset errors of the observation times of the training symbols, wherein constants in the third polynomial equation are determined using at least the observations, and wherein the roots of the second variable correspond to the possible symbol timing offset errors.

24. A computer program product tangibly embodying a program of machine-readable instructions executable by a digital processing apparatus to perform operations comprising:
determining a plurality of observations, each observation occurring at an observation time and corresponding to one of a plurality of received frequency multiplexed training symbols;
determining a plurality of roots of a first polynomial equation that is a function of a variable corresponding to frequency offset errors of carrier frequencies of the training symbols, wherein constants in the first polynomial equation are determined using at least the observations, and wherein the roots of the variable correspond to possible frequency offset errors;
based on at least the observations, the possible frequency offset errors, and possible symbol timing offset errors of the observation times of the training symbols, determining a plurality of estimated channel responses corresponding to the training symbols;
using a second polynomial equation that is a function of at least the estimated channel responses, the possible frequency offset errors, and the possible symbol timing offset errors, determining at least a resultant frequency offset error and a resultant symbol timing offset error; and
using the resultant frequency offset error and resultant symbol timing offset error in order to receive at least one frequency multiplexed data symbol.

25. The computer program product of claim 24, wherein the first polynomial equation is formed using a partial derivative, with respect to the frequency offset error, of a logarithm of the second polynomial equation.

26. The computer program product of claim 24, wherein the operation of determining at least a resultant frequency offset error and a resultant symbol timing offset error further comprises the operation of finding a combination of one of the estimated channel responses, one of the possible frequency offset errors, and one of the possible symbol timing offset errors such that the combination causes a value corresponding to the second polynomial equation to meet at least one predetermined criterion.

27. The computer program product of claim 24, wherein the operation of determining at least a resultant frequency offset error and a resultant symbol timing offset error comprises finding a combination of one of the estimated channel responses, one of the possible frequency offset errors, and one of the possible symbol timing offset errors that minimizes values of a negative logarithm of the second polynomial equation.

28. The computer program product of claim 24, wherein:
the possible symbol timing offset errors comprise a plurality of hypothesized symbol timing offset errors;
the polynomial equation is also a function of the symbol timing offset error; and
the operation of determining a plurality of roots further comprises the operation of determining a set of roots of the polynomial equation for each of the hypothesized symbol timing offset errors, each set of roots comprising a plurality of roots.

29. The computer program product of claim 28, wherein the operation of determining a plurality of roots of a first polynomial equation further comprises the operations of:
for each hypothesized symbol timing offset error, computing values corresponding to the first polynomial equation for each of the plurality of observations;
passing the computed values through a low pass, zero-phase filter to create filtered values;
decimating the filtered values to create decimated values;
forming a decimated version of the first polynomial equation from the decimated values; and
using the decimated version of the first polynomial equation to determine the plurality of roots.

30. The computer program product of claim 24, wherein:
the plurality of roots of the first polynomial equation are first roots and the variable is a first variable; and
the operations further comprise determining a second plurality of roots of a third polynomial equation that is a function of a second variable corresponding to symbol timing offset errors of the observation times of the training symbols, wherein constants in the third polynomial equation are determined using at least the observations, and wherein the roots of the second variable correspond to the possible symbol timing offset errors.

31. An apparatus comprising:
synchronization means coupleable to a reception means and configured to receive from the reception means information corresponding to a plurality of observations, each observation occurring at an observation time and corresponding to one of a plurality of received frequency multiplexed training symbols, the synchronization means for determining a plurality of roots of a first polynomial equation that is a function of a variable corresponding to frequency offset errors of carrier frequencies of the training symbols, wherein constants in the first polynomial equation are determined using at least the observations, and wherein the roots of the variable correspond to possible frequency offset errors, the synchronization means further, based on at least the observations, the possible frequency offset errors, and possible symbol timing offset errors of the observation times of the training symbols, for determining a plurality of estimated channel responses corresponding to the training symbols, the synchronization means also for, using a second polynomial equation that is a function of at least the estimated channel responses, the possible frequency offset errors, and the possible symbol timing offset errors, determining at least a resultant frequency offset error and a resultant symbol timing offset error, and the synchronization means for causing the means for receiving to use the resultant frequency offset error and resultant symbol timing offset error in order to receive at least one frequency multiplexed data symbol.

32. The apparatus of claim 31, further comprising the means for receiving coupled to the synchronization means.
